(19) United States
(12) Patent Application Publication
(10) Pub. No.: US 2025/0026117 A1
(43) Pub. Date: Jan. 23, 2025

(54) RECYCLABLE HIGH BARRIER PAPER-BASED COMPOSITE PACKAGING STRUCTURES

(71) Applicant: PROAMPAC HOLDINGS INC., Cincinnati, OH (US)

(72) Inventors: Adam J. Edinger, Rochester, NY (US); Raymond J. Recchia, Cincinnati, OH (US); Terry J. Leis, Huntington, MA (US); James E. Tierney, South Hadley, MA (US); Seyed Hesamoddin Tabatabaei, Mason, OH (US); Amir Saffar, Laval (CA)

(21) Appl. No.: 18/778,929

(22) Filed: Jul. 20, 2024

Related U.S. Application Data
(60) Provisional application No. 63/528,303, filed on Jul. 21, 2023.

(51) Int. Cl. B32B 29/00; B32B 7/12; B32B 27/10

(52) U.S. Cl. CPC B32B 29/00; B32B 7/12; B32B 27/10; B32B 2250/04; B32B 2250/05; B32B 2307/7244; B32B 2307/7246; B32B 2307/75; B32B 2439/00

(57) ABSTRACT

Recyclable, paper-based composite film structures comprise a first ply comprising a paper substrate having a first major surface configured to face away from a packaged product. A second ply comprises a heat sealable polymer layer having a first major surface configured to face toward the paper substrate second major surface. The second major surface of the heat sealable polymer layer forms an innermost surface of the film structure. In some embodiments, a barrier layer is disposed on the first or second major surface of the paper substrate and an adhesion promotor is disposed intermediate the paper substrate and the heat sealable polymer layer. In alternative embodiments a barrier layer is disposed on the first major surface of the heat sealable polymer layer and the first and second plies are adhesively laminated. In embodiments, an adhesion promotor is disposed intermediate the paper substrate and the heat sealable polymer layer.

### CROSS REFERENCE TO RELATED APPLICATION

This application claims the priority benefit of U.S. provisional application No. 63/528,303 filed Jul. 21, 2023. The aforementioned application is incorporated herein by reference in its entirety.

### BACKGROUND

The present invention relates to a recyclable, high-barrier, paper-based packaging structure comprising an outer ply including a paper substrate secured to an inner ply having a heat sealable polymer layer. One or both of the inner ply and the outer ply includes a barrier layer. An adhesion promoter is provided to improve adhesion between the inner ply and the outer ply.

Flexible polymer films are widely used as packaging materials for bags, pouches, and then like. Flexible polymer films are versatile due to their ability to easily bend, fold, and conform to various shapes, making them suitable for packaging a wide range of products, including food, beverages, personal care items, and others. The thin and lightweight nature of such films allow for efficient storage, transportation, and display of the packaged goods.

Commonly, such flexible polymer films are composite structures formed of different materials chosen for specific properties. For instance, barrier layers for protecting the package contents from external elements like moisture and gases may be made from foils, metallized structures, or polymers different than a substrate layer or heat sealant layer. Although this selective layering optimizes the film's performance, the composite nature of such films can present challenges for recyclability. Separating and recycling the different layers of such materials can be technically complex if not impossible. As such, packaging made from such film can have a negative environmental impact since they can end up in landfills or the environment where they can persist for many years.

The present disclosure contemplates a new and improved recyclable, high-barrier, paper-based packaging structure which overcomes the above-referenced problems and others.

### SUMMARY

In one aspect, a recyclable, paper-based composite film structure comprises a first ply comprising a paper substrate having a first major surface and a second major surface opposite the first major surface. The first major surface of the paper substrate is configured to face away from a product to be packaged. A barrier layer is disposed on one of the first major surface of the paper substrate and the second major surface of the paper substrate. A heat sealable polymer layer has a first major surface and a second major surface opposite the first major surface, the first major surface of the heat sealable polymer layer configured to face toward the second major surface of the paper substrate and the second major surface of the heat sealable polymer layer configured to form an innermost surface of the recyclable, paper-based composite film structure. An adhesion promotor is disposed intermediate the paper substrate and the heat sealable polymer layer.

In another aspect, a recyclable, paper-based composite film structure comprises a first ply comprising a paper substrate having a first major surface and a second major surface opposite the first major surface. The first major surface of the paper substrate is configured to face away from a product to be packaged. A second ply comprises a heat sealable polymer layer having a first major surface and a second major surface opposite the first major surface. The first major surface of the heat sealable polymer layer is configured to face toward the second major surface of the paper substrate. The second major surface of the heat sealable polymer layer is configured to form an innermost surface of the recyclable, paper-based composite film structure. A barrier layer is disposed on the first major surface of the heat sealable polymer layer. An adhesive layer intermediate the first ply and the second ply bonds the first ply to the second ply. An adhesion promotor is disposed intermediate the paper substrate and the heat sealable polymer layer.

In further aspects, methods for the manufacture of composite packaging films are provided. In still further aspects, packaging articles formed of the composite packaging films herein are provided.

One advantage of the present development resides in the recyclability of the packaging structures herein.

Another advantage of the present development resides in their oxygen and moisture barrier properties.

Yet another advantage of the packaging structures herein is found in their ability to resist grease or oil permeation.

Yet another advantage of the packaging structures herein is found in their heat sealability.

Still another advantage of the packaging structures herein is the ability to utilize materials that have regulatory approval such as FDA approval for use in food applications or food contact applications.

Another advantage of the present disclosure is that it offers a replacement for conventional nonrecyclable barrier films having foil or metallized barrier layers.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is a cross sectional view of a recyclable, high-barrier, paper-based packaging structure in accordance with a first embodiment.

FIG. 1B is a cross sectional view of a recyclable, high-barrier, paper-based packaging structure in accordance with a second embodiment.

FIG. 1C is a cross sectional view of a recyclable, high-barrier, paper-based packaging structure in accordance with a third embodiment.

FIG. 1D is a cross sectional view of a recyclable, high-barrier, paper-based packaging structure in accordance with a fourth embodiment.

FIG. 2A is a cross sectional view of a recyclable, high-barrier, paper-based packaging structure in accordance with a fifth embodiment.

FIG. 2B is a cross sectional view of a recyclable, high-barrier, paper-based packaging structure in accordance with a sixth embodiment.

FIG. 2C is a cross sectional view of a recyclable, high-barrier, paper-based packaging structure in accordance with a seventh embodiment.

FIG. 2D is a cross sectional view of a recyclable, high-barrier, paper-based packaging structure in accordance with a eighth embodiment.

FIG. 3A is a cross sectional view of a recyclable, high-barrier, paper-based packaging structure in accordance with a ninth embodiment.

FIG. 3B is a cross sectional view of a recyclable, high-barrier, paper-based packaging structure in accordance with a tenth embodiment.

FIG. 4A is a cross sectional view of a recyclable, high-barrier, paper-based packaging structure in accordance with an eleventh embodiment.

FIG. 4B is a cross sectional view of a recyclable, high-barrier, paper-based packaging structure in accordance with a twelfth embodiment.

FIG. 4C is a cross sectional view of a recyclable, high-barrier, paper-based packaging structure in accordance with a thirteenth embodiment.

FIG. 4D is a cross sectional view of a recyclable, high-barrier, paper-based packaging structure in accordance with a fourteenth embodiment.

FIG. 5A illustrates an exemplary process line flow chart for forming the recyclable, high-barrier, paper-based packaging structure in accordance with FIG. 1A.

FIG. 5B illustrates an exemplary process line flow chart for forming the recyclable, high-barrier, paper-based packaging structure in accordance with FIG. 1B.

FIG. 5C illustrates an exemplary process line flow chart for forming the recyclable, high-barrier, paper-based packaging structure in accordance with FIG. 1C.

FIG. 5D illustrates an exemplary process line flow chart for forming the recyclable, high-barrier, paper-based packaging structure in accordance with FIG. 1D.

FIG. 6A illustrates an exemplary process line flow chart for forming the recyclable, high-barrier, paper-based packaging structure in accordance with FIG. 2A.

FIG. 6B illustrates an exemplary process line flow chart for forming the recyclable, high-barrier, paper-based packaging structure in accordance with FIG. 2B.

FIG. 6C illustrates an exemplary process line flow chart for forming the recyclable, high-barrier, paper-based packaging structure in accordance with FIG. 2C.

FIG. 6D illustrates an exemplary process line flow chart for forming the recyclable, high-barrier, paper-based packaging structure in accordance with FIG. 2D.

FIG. 7A illustrates an exemplary process line flow chart for forming the recyclable, high-barrier, paper-based packaging structure in accordance with FIG. 3A.

FIG. 7B illustrates an exemplary process line flow chart for forming the recyclable, high-barrier, paper-based packaging structure in accordance with FIG. 3B.

FIG. 8A illustrates an exemplary process line flow chart for forming the recyclable, high-barrier, paper-based packaging structure in accordance with FIG. 4A.

FIG. 8B illustrates an exemplary process line flow chart for forming the recyclable, high-barrier, paper-based packaging structure in accordance with FIG. 4B.

FIG. 8C illustrates an exemplary process line flow chart for forming the recyclable, high-barrier, paper-based packaging structure in accordance with FIG. 4C.

FIG. 8D illustrates an exemplary process line flow chart for forming the recyclable, high-barrier, paper-based packaging structure in accordance with FIG. 4D.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the terms “a” or “an,” are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

As used herein, the terms “front,” “rear,” “upper,” “lower,” “upwardly,” “downwardly,” “left,” “right,” and other orientation descriptors are intended to facilitate the description of the exemplary embodiments of the present invention, and are not intended to limit the structure thereof to any particular position or orientation.

The terms “exterior” and “interior” are used herein to refer to a position in relation to a product to be packaged using the multilayer packaging structures herein, while the terms “outer” and “inner” are used herein to refer to a position in relation to other layers of the multilayer packaging structures herein.

As used herein, the term “exterior layer” refers to a layer of a multilayer packaging structure which is furthest from the product to be packaged in relation to the other layers of the multilayer structure. The term “exterior facing surface” of a layer of a multilayer packaging structure is the surface of such layer that faces away from the product being packaged within a multilayer packaging structure herein or a packaging article formed thereof. Likewise, the term “exterior surface” of a multilayer packaging structure is the surface of the structure that is intended to face away from a product being packaged within the structure.

As used herein, the term “interior layer” refers to a layer of a multilayer packaging structure which is closest to or is intended to contact the product to be packaged within a multilayer structure herein in relation to the other layers of the multilayer structure. The term “interior facing surface” of a layer of a multilayer packaging structure herein is the surface of such layer that faces toward the product being packaged within a multilayer packaging structure herein or a packaging article formed thereof. Likewise, the term “interior surface” of a multilayer packaging structure herein is the surface of the structure that faces toward or is intended to face toward or contact a product being packaged within the structure.

As used herein, the term “inner layer” refers to a layer within a multilayer packaging structure herein is that is not exposed to handling and the environment. Inner layers may provide functionality as needed for particular applications. For example, inner layers may provide barrier protection and/or structural strength. As an example, an exemplary inner layer provides protection to packaged food or other product for freshness and/or a barrier to moisture and/or oxygen, and/or a barrier to migration of moisture, oils, and the like from packaged food or other product from the interior surface of the multilayer packaging structure to the exterior surface of the multilayer packaging structure. As another example, an inner layer may also be a structural layer which provides one properties including but not limited to general durability, puncture strength, resistance to curling, tear or flex crack resistance, and the like.

As used herein, the term “outer layer” refers to a layer which comes in immediate contact with the outside environment or atmosphere. Therefore, the multilayer packaging structures herein have two outer layers, namely, the interior layer and the exterior layer.

As used herein, the term “compostable” means that a material is capable of breaking down into non-toxic components in the presence of oxygen, moisture, and microorganisms which facilitate the breakdown of organic matter. In embodiments, the term “compostability” is intended to refer to any one of more of marine compostability (the ability of a material to decompose in a marine or aquatic environment), industrial compostability (the ability of a material to degrade within an industrial composting facility) and home compostability (the ability of a material to decompose in a backyard or home composting system).

As used herein, “recyclable” may refer to a paper-based product that is eligible for acceptance into paper recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability.

As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

As used herein, the terms “grease resistant” or “grease resistance” refer to the character of the barrier layer in blocking or impeding the absorption or transmission of grease or oil in any significant quantity.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the term “surface treatment” means a surface modification treatment to increase the surface energy of a material, which can improve adhesion between two surfaces.

As used herein, the term “packaging structure” means a web of sheet material having a structure as disclosed herein, as well as a packaging article manufactured therefrom, including sheets or wraps, bags, pouches, and the like.

As used herein “fiber components” refers to the paper material in a composite, including any cellulose fibers or pulp.

As used herein, “non-fiber components” refers to non-paper material in a composite, including any polymer films, coatings, lamination adhesives, or any other non-paper elements in the composite.

All compositional percentages used herein are presented on a “by weight” basis, unless specifically stated otherwise.

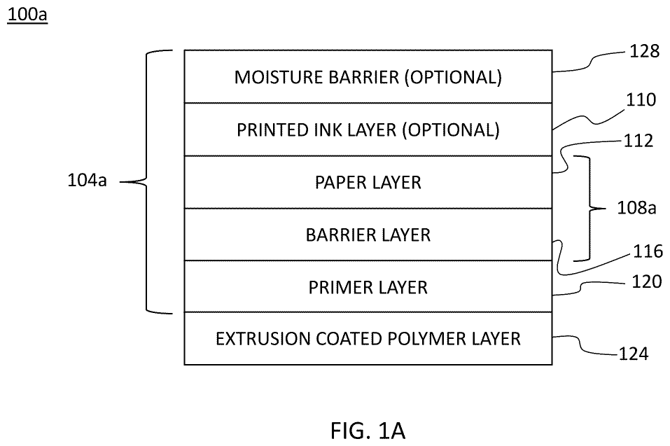

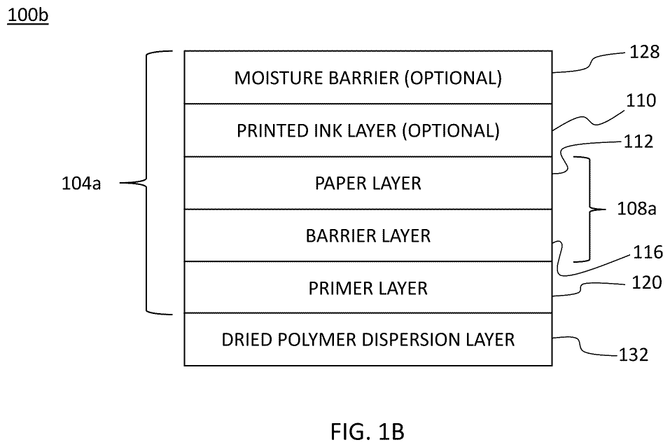

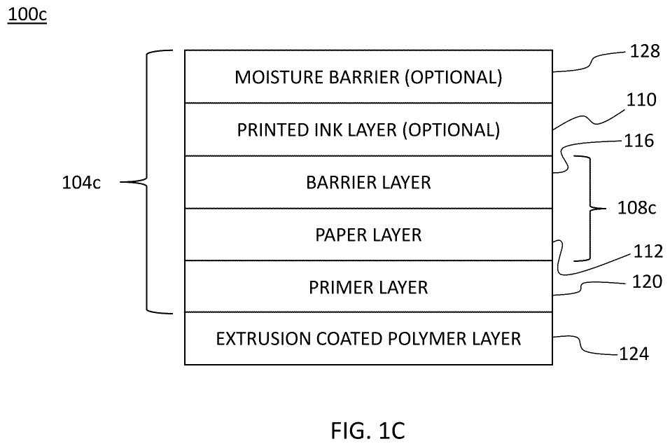

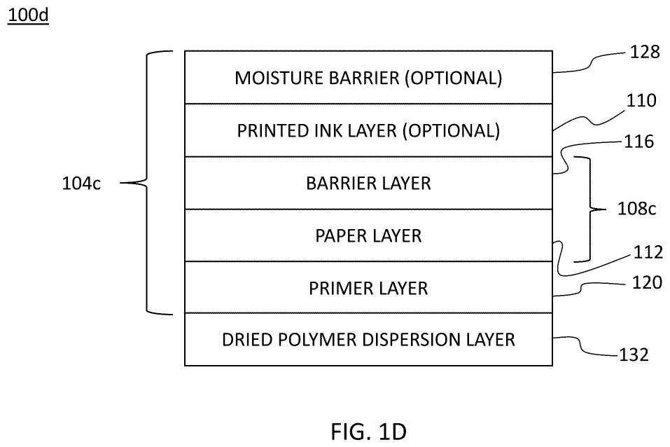

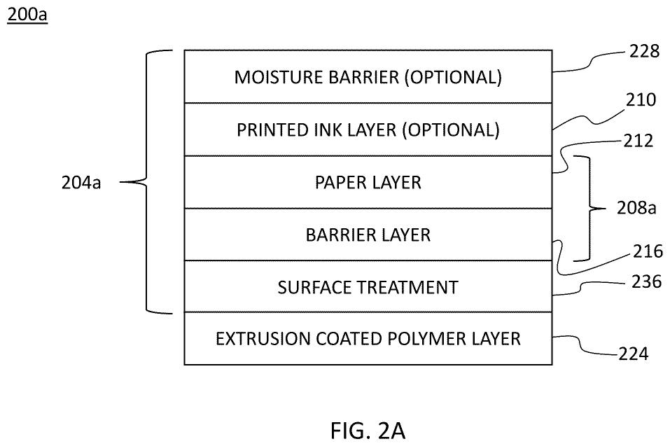

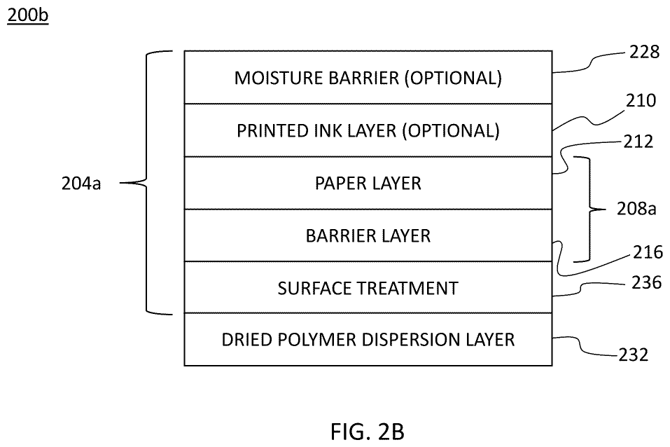

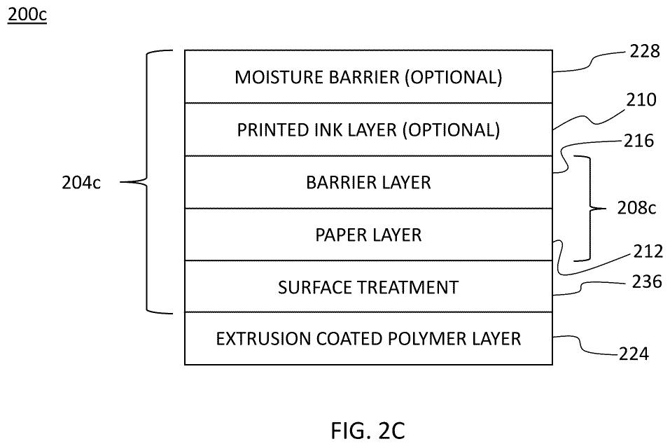

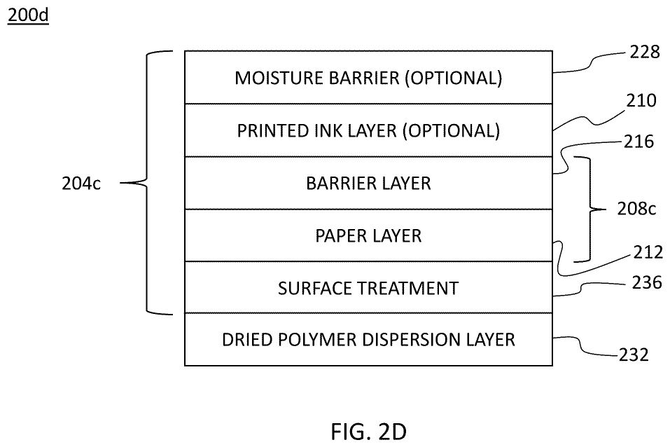

Referring now to the drawings, like reference numerals are used to describe like or analogous items in which the hundreds digit has been increased to correspond to the figure number (e.g., paper layer 112 in FIG. 1A corresponds to paper layer 212 in FIG. 2A, and so forth). The description in reference to any given reference numeral herein is equally applicable to other reference numerals that differ only in the hundreds digit, unless specifically stated otherwise.

Referring now to FIG. 1A, a packaging structure 100a comprises a first ply 104a and an extrusion coated polymer layer 124 attached to the interior facing surface of the first ply 104a. The first ply 104a includes a barrier coated paper substrate 108a comprising a paper layer 112 and a barrier layer 116. The paper layer 112 has a first major surface, which is an exterior facing surface, and a second major surface, which is an interior facing surface, the second major surface opposite the first major surface. The barrier layer 116 is disposed on the second major surface of the paper layer 112. An adhesion promotor, which is a primer layer 120 in the embodiment illustrated in FIG. 1A, is disposed on the barrier layer 116, i.e., on the interior facing surface of the barrier coated paper substrate 108a.

In embodiments, the paper layer 112 is a paper material having a basis weight ranging from 20 pounds per ream to 100 pounds per ream. In embodiments, the basis weight of the paper layer 112 is 20 #/ream, 30 #/ream, 40 #/ream, 50 #/ream, 60 #/ream, 70 #/ream, 80 #/ream, 90 #/ream, or 100 #/ream. Unless specified otherwise, all basis weights herein are based on a 3000 square foot ream. Specific examples of paper materials include specific examples thereof include bleached Kraft paper, unbleached Kraft paper, wood-free paper, paperboard, glassine paper, semi-glassine paper, parchment paper, and the like. In embodiments, the paper layer 112 provides good dead fold or crease retention properties to the structure 100a and has good printability, e.g., for printing packaging indicia such as product information, branding indicia, and the like.

In embodiments, the barrier layer 116 is a moisture barrier, oxygen barrier, or both. In embodiments, the barrier layer 116 is configured to provide a barrier to both oxygen and moisture. Such barriers include inorganic, e.g., ceramic coatings, such as inorganic oxides, nitrides, or carbides. In embodiments the barrier layer is selected from an aluminum oxide (AlOx) coating, silicon oxide (SiOx) coating, or a coating comprising a blend of AlOx and SiOx.

In embodiments, the barrier layer 116 comprises a metallization layer formed of a metal such as aluminum. In embodiments, when the barrier coating 116 is a ceramic barrier layer or a metallization layer, the barrier coating 116 is applied to the paper layer 112 using a coating or deposition technique, such as physical vapor deposition (PVD), thermal evaporation physical vapor deposition (TEPVD), sputter deposition, magnetron sputter deposition, ion beam sputter deposition, chemical vapor deposition (CVD), plasma enhanced chemical vapor deposition (PECVD), and sol-gel coating to form the barrier paper substrate 108a.

In embodiments, the barrier layer 116 has a thickness in the range of 1 nm to 10 μm. In embodiments, when the barrier layer 116 is a metallization layer, the barrier layer 116 has a thickness in the range of 1 nm to 5 μm, and more preferably 2 μm. In embodiments, when the barrier layer 116 is a ceramic barrier layer, the barrier layer 116 has a thickness in the range of 1 nm to 20 nm, and more preferably 10 nm.

In certain embodiments, the barrier layer 116 is configured to withstand folding and prevent flex cracking to avoid losing barrier properties. Flex crack resistance can be controlled through a number of factors, such as coating thickness, deposition temperature, pressure, and rate, among others.

In embodiments, the barrier layer 116 is configured to provide the structure 100a with an oxygen transmission rate (OTR) in the range of 0.001 cc/100 in²/day to 5 cc/100 in²/day (when tested at 23° C. and 50% relative humidity).

In embodiments, the barrier layer 116 is configured to provide the structure 100a with a water vapor transmission rate (WVTR) in the range of 0.001 cc/100 in²/day to 5 cc/100 in²/day (when tested at 23° C. and 85% relative humidity).

In embodiments, the barrier layer 116 is an oxygen barrier layer. In such embodiments the barrier layer 116 may be a polyvinyl alcohol (PVOH) coating layer. In embodiments, the PVOH is applied as an extrusion coating layer onto the second major surface of the paper layer 112 to form the barrier paper substrate 108a. In embodiments, the PVOH has a thickness in the range of from about 0.25 mil to about 5 mil. In certain embodiments, the PVOH layer 116 has a thickness in the range of about 0.3 mil to about 1 mil.

In certain embodiments, the PVOH layer 116 is an extrusion coating having a thickness in the range of about 0.25 mil to about 5 mil, e.g., 0.25 mil, 0.5 mil, 0.75 mil, 1.0 mil, 1.25 mil, 1.5 mil, 1.75 mil, 2.0 mil, 3.25 mil, 3.5 mil, 3.75 mil, 4.0 mil, 4.25 mil, 4.5 mil, 5.75 mil, or 5.0 mil.

In certain embodiments, the PVOH layer 116 is a solution coating layer having a thickness in the range of about of about 1 nm to about 10 μm. In certain embodiments, the PVOH layer 116 is a solution coating layer having a thickness in the range of about of about 3 μm to about 5 μm.

In embodiments, when the barrier layer 116 is PVOH, the barrier layer 116 is configured to provide the structure 100a with an oxygen transmission rate (OTR) in the range of 0.001 cc/100 in²/day to 5 cc/100 in²/day (when tested at 23° C. and 50% relative humidity).

The primer layer 120 plays a role in adhering the first ply 104a to the second ply 140a. In embodiments, the primer layer 120 is a water-based or organic solvent-based primer. Exemplary primers include polyethyleneimines (PEI), ethylene-acrylic acid (EAA) copolymers, ethylene-ethyl acrylate (EEA) copolymers, polyurethanes, polyvinyl alcohols, poly acrylic acids (PAA), and polyacrylates.

The method for forming the primer layer 120 can be any method. In embodiments, the primer is a water or organic solvent based coating that can be diluted with water or organic solvent and used. The primer coating 120 is applied to the surface of a substrate suitably using a known method, such as roll coating, roll-to-roll coating, various types of gravure coating, flexographic coating, bar coating, doctor blade coating, comma coating, spraying, or brush coating.

The solvent for use in forming the primer layer 120 can be any solvent. Examples include water and alkanols, e.g., ethanol and isopropanol. The concentration of the primer can be suitably determined in accordance with coating suitability and the desired thickness or coating density of the coating film.

In certain embodiments, the primer layer 120 is applied with a coating basis weight of from about 0.25 lb/3000 ft² to about 2.0 lb/3000 ft² wet, and more preferably about 0.5 lb/3000 ft² to about 1.0 lb/3000 ft² wet.

An optional printed ink layer 110 is disposed on the first major surface of the paper layer 112. The printed ink layer 110 may include one or more of inks, pigments, dyes, and the like, e.g., for providing one or more visible indica on the exterior of the structure 100a.

The printing ink layer 110 can be applied to the first major surface of the paper substrate 112 via any conventional printing method as would be understood by persons skilled in the art, including without limitation, using a rotogravure printing apparatus, flexographic printing apparatus, offset printing apparatus, digital printing apparatus, ink jet printing apparatus, or the like. In embodiments, the printing ink layer 110 is intended to additionally include varnishes or over lacquers applied to the ink layer 110 as would be understood by persons skilled in the art, e.g., to protect the ink(s) from scuffing and rubbing off and/or to provide a desired matte or gloss effect.

An optional moisture barrier coating layer 128 may be provided over the printed ink layer 110 if the printed ink layer 110 is present, or, on the first major surface of the paper layer 112 if the if the printed ink layer 110 is omitted. In embodiments, the moisture barrier layer 128 is a dried polymer dispersion, wherein the moisture barrier is applied as a coating in the form of an aqueous or non-aqueous solvent-based polymer dispersion and then dried. Exemplary solvents include water, ethanol, and isopropanol. Exemplary polymers include polyacrylates, latex, waxes (e.g., animal waxes, vegetable waxes, mineral waxes, and petroleum waxes), polystryenes, and polyolefins (e.g., polyethylenes and polypropylenes). The aqueous or non-aqueous solvent-based polymer dispersion is applied by a suitable coating technique, such as roll coating, roll-to-roll coating, various types of gravure coating, flexographic coating, bar coating, doctor blade coating, comma coating, spraying, or brush coating. The solvent is removed using heat, vacuum, forced hot air, drying oven, or the like. In embodiments, the printed ink layer and the optional moisture barrier coating are applied together in a single step using a printing apparatus.

The extrusion coated polymer layer 124 forms an innermost layer of the structure 100a. The extrusion coated polymer layer 124 is preferably formed of a polymer having good heat scalable properties. In embodiments, the extrusion coated polymer layer 124 has a basis weight in the range of 1 #/ream to 10 #/ream, e.g., 1 #/ream, 2 #/ream, 3 #/ream, 4 #/ream, 5 #/ream, 6 #/ream, 7 #/ream, 8 #/ream, 9 #/ream, or 10 #/ream.

In embodiments, the extrusion coated polymer layer 124 is formed of a polyolefin-based polymer or copolymer material, preferably a polyethylene-based or polypropylene-based polymer material. In embodiments, the extrusion coated polymer layer 124 may comprise a monomaterial or a blend. In certain embodiments, the extrusion coated polymer layer 124 is formed of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), or blends thereof as well as coextrusions thereof.

In embodiments, the extrusion coated polymer layer 124 is formed of an acrylic polymer or copolymer. In embodiments, the extrusion coated polymer layer 124 is formed of a polymer material selected from methacrylic acid (MAA) polymers, ethylene acrylic acid (EAA) polymers, ethylene-methacrylic acid (EMAA) copolymers, ethylene-methyl acrylate (EMA) copolymers, ethylene-methyl methacrylate (EMMA) copolymers, ethylene-ethyl acrylate (EEA) copolymers, ethylene-butyl acrylate (EBA) copolymers, and ethylene n-butyl acrylate (EnBA) copolymers, acrylic acid-ethyl acrylate (AA-EA) copolymers, methacrylic acid ethyl acrylate (MAA-EA) copolymers, or blends or coextrusions thereof. In alternative embodiments, the extrusion coated polymer layer 124 is formed of an ethylene vinyl acetate (EVA) polymer or a polyvinyl alcohol (PVOH) polymer.

In certain embodiments, the extrusion coated polymer layer 124 has a thickness in the range of about 0.25 mil to about 5 mil. In certain embodiments, the extrusion coated polymer layer 124 has a thickness in the range of about 0.3 mil to about 1 mil. In certain embodiments, the extrusion coated polymer layer 124 has a thickness of about 0.25 mil, 0.5 mil, 0.75 mil, 1.0 mil, 1.25 mil, 1.5 mil, 1.75 mil, 2.0 mil, 3.25 mil, 3.5 mil, 3.75 mil, 4.0 mil, 4.25 mil, 4.5 mil, 5.75 mil, or 5.0 mil. In embodiments the extrusion coated polymer layer 124 comprises PVOH.

In embodiments, the composition of the layers is such that the non-fiber components in the composite structure 100a do not exceed 20% by weight of the total weight of the structure 100a. In embodiments, the composition of the layers is such that the non-fiber components in the composite structure 100a do not exceed 15% by weight of the total weight of the structure 100a. In embodiments, the composition of the layers is such that the non-fiber components in the composite structure 100a do not exceed 10% by weight of the total weight of the structure 100a. In embodiments, the composition of the layers is such that the non-fiber components in the composite structure 100a do not exceed 5% by weight of the total weight of the structure 100a. In certain embodiments, the composition of the packaging structure 100a is such that total weight of the polymer materials and other nonfibrous components does not exceed a maximum amount of plastics or non-paper components in accordance with an established standard or guideline for paper recyclability and/or repulpability.

In embodiments, the packaging structure 100a includes one or more water soluble components, such as a water soluble barrier layer 116 (e.g., PVOH). In certain embodiments, the weight of the non-water soluble nonfibrous components minus the weight of any water soluble components does not exceed 20% by weight of the total weight of the packaging structure 100a minus the weight of any water soluble components. In certain embodiments, the weight of the non-water soluble nonfibrous components minus the weight of any water soluble components does not exceed 15% by weight of the total weight of the packaging structure 100a minus the weight of any water soluble components. In certain embodiments, the weight of the non-water soluble nonfibrous components minus the weight of any water soluble components does not exceed 10% by weight of the total weight of the packaging structure 100a minus the weight of any water soluble components. In certain embodiments, the weight of the non-water soluble nonfibrous components minus the weight of any water soluble components does not exceed 5% by weight of the total weight of the packaging structure 100a minus the weight of any water soluble components. In certain embodiments, the composition of the packaging structures herein is such that total weight of the non-water soluble nonfibrous components does not exceed a maximum amount of plastics or non-paper components in accordance with an established standard or guideline for paper recyclability and/or repulpability.

In embodiments, the structure 100a is configured to resist grease penetration. In embodiments, the structure 100a has a Krebs Interfacial Tension (KIT) test grease resistance value of 10 or higher. In embodiments, the structure 100a has a KIT value of 12 or higher. All KIT values herein are based on the test method described in the TAPPI T559 cm-12 testing standard developed by the Technical Association of the Pulp and Paper Industry (TAPPI).

In embodiments, the extrusion coated polymer layer 124 has a seal initiation temperature (SIT) in the range of 200° F. to 350° F., In embodiments, the extrusion coated polymer layer 124 has a SIT in the range of 225° F. to 325° F. In embodiments, the extrusion coated polymer layer 124 has a SIT in the range of 250° F. to 300° F. The relatively low heat seal initiation temperatures allow the packaging structure 100a to run on vertical form fill seal (VFFS) and horizontal form fill seal (HFFS) at high speeds.

In embodiments, the coefficient of kinetic friction of the inward facing surface of the packaging structure 100a sliding or moving against itself is 0.4 or less. In embodiments, the coefficient of static friction of the inward facing surface of the packaging structure 110a when attempting to initiate movement against itself is 0.4 or less. The relatively low coefficients of friction provide runability on filling equipment.

In embodiments, the packaging structure 100a recyclable in a curbside paper recycling streams and is configured to replace current packaging films having foil or metallized barriers.

In embodiments, the packaging structure 100a is configured to meet standards established by the U.S. Food and Drug Administration (FDA) for use in food applications or food contact applications.

Referring now to FIG. 1B, a packaging structure 100b comprises a first ply 104a and a dried polymer dispersion layer 132 attached to the interior facing surface of the first ply 104a. The first ply 104a is as described above by way of reference to FIG. 1A.

The dried polymer dispersion layer 132 forms an innermost layer of the structure 100b. The dried polymer dispersion layer 132 is preferably formed of a polymer having good heat scalable properties.

The dried polymer dispersion layer 132 is formed using a dispersion or colloidal system comprising a polymer and a liquid medium. The dispersion is applied in the form of a coating layer and the solvent/liquid is removed/evaporated to form a solid polymer film layer. In embodiments, the dried polymer dispersion layer 132 has a basis weight in the range of has a basis weight in the range of 1 #/ream to 10 #/ream, e.g., 1 #/ream, 2 #/ream, 3 #/ream, 4 #/ream, #/ream, 6 #/ream, 7 #/ream, 8 #/ream, 9 #/ream, or 10 #/ream (after drying). In embodiments, the wet dispersion coating is applied using roll coating, reverse roll coating, gravure coating, slot die coating, spray coating, and the like.

In embodiments, the dried polymer dispersion layer 132 is formed of a polyolefin-based polymer or copolymer material, preferably a polyethylene-based or polypropylene-based polymer material. In embodiments, the dried polymer dispersion layer 132 may comprise a monomaterial or a blend. In certain embodiments, the dried polymer dispersion layer 132 is formed of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), or blends thereof.

In embodiments, the dried polymer dispersion layer 132 is formed of an acrylic polymer or copolymer. In embodiments, the dried polymer dispersion layer 132 is formed of methacrylic acid (MAA), ethylene acrylic acid (EAA), ethylene-methacrylic acid (EMAA) copolymers, ethylene-methyl acrylate (EMA) copolymers, ethylene-methyl methacrylate (EMMA) copolymers, ethylene-ethyl acrylate (EEA) copolymers, ethylene-butyl acrylate (EBA) copolymers, and ethylene n-butyl acrylate (EnBA) copolymers, acrylic acid-ethyl acrylate (AA-EA) copolymers, methacrylic acid ethyl acrylate (MAA-EA) copolymers, or blends thereof. In alternative embodiments, the dried polymer dispersion layer 132 is formed of an ethylene vinyl acetate (EVA) polymer or a polyvinyl alcohol (PVOH) polymer.

In embodiments, the dried polymer dispersion layer 132 has a seal initiation temperature (SIT) in the range of 200° F. to 350° F., In embodiments, the dried polymer dispersion layer 132 has a SIT in the range of 225° F. to 325° F. In embodiments, the dried polymer dispersion layer 132 has a SIT in the range of 250° F. to 300° F.

Referring now to FIG. 1C, there is shown a packaging structure 100c comprising a first ply 104c and an extrusion coated polymer layer 124 attached to the interior facing surface of the first ply 104c. The first ply 104c includes a barrier coated paper layer 108c. The barrier coated paper layer 108c comprises a paper substrate 112 having a first major surface which is exterior facing and a second major surface opposite the first major surface and a barrier layer 116 formed on the first major surface of the paper substrate 112.

In embodiments, a printed ink layer 110 is optionally disposed on the exterior facing surface of the barrier coated paper layer 108c. In embodiments, a moisture barrier layer 128 is optionally disposed on the exterior facing surface of the barrier coated paper layer 108c. In embodiments, a printed ink layer 110 is optionally disposed on the exterior facing surface of the barrier coated paper layer 108c and a moisture barrier layer 128 is optionally disposed on the exterior facing surface of the printed ink layer 110.

The packaging structure 100c differs from the packaging structure 100a shown and described above by way of reference to FIG. 1A in that the barrier layer 116 is disposed on the first major surface of the paper layer 112 and the primer layer 120 is in direct contact with the second major surface of the paper layer 112. Except for these differences, the description of the structure 100a in FIG. 1A is equally applicable to the structure 100c appearing in FIG. 1C.

Referring now to FIG. 1D, there is shown a packaging structure 100d comprising a first ply 104c and a dried polymer dispersion layer 132 attached to the interior facing surface of the first ply 104c. The first ply 104c includes a barrier coated paper layer 108c. The barrier coated paper layer 108c comprises a paper substrate 112 having a first major surface which is exterior facing and a second major surface opposite the first major surface and a barrier layer 116 formed on the first major surface of the paper substrate 112.

In embodiments, a printed ink layer 110 is optionally disposed on the exterior facing surface of the barrier coated paper layer 108c. In embodiments, a moisture barrier layer 128 is optionally disposed on the exterior facing surface of the barrier coated paper layer 108c. In embodiments, a printed ink layer 110 is optionally disposed on the exterior facing surface of the barrier coated paper layer 108c and a moisture barrier layer 128 is optionally disposed on the exterior facing surface of the printed ink layer 110.

The packaging structure 100d differs from the packaging structure 100b shown and described above by way of reference to FIG. 1B in that the barrier layer 116 is disposed on the first major surface of the paper layer 112 and the primer layer 120 is in direct contact with the second major surface of the paper layer 112. Except for these differences, the description of the structure 100b in FIG. 1B is equally applicable to the structure 100d appearing in FIG. 1D.

Referring now to FIG. 2A, there is shown a packaging structure 200a comprising a first ply 204a having an extrusion coated polymer layer 224 on an interior facing surface thereof. The first ply 204a includes a barrier coated paper layer 208a. The barrier coated paper layer 208a comprises a paper substrate 212 having a first major surface which is exterior facing and a second major surface opposite the first major surface and a barrier layer 216 formed on the second major surface of the paper substrate 212.

In embodiments, a printed ink layer 210 is optionally disposed on the first major surface of the paper substrate 212. In embodiments, a moisture barrier layer 228 is optionally disposed on the first major surface of the paper substrate 212. In embodiments, a printed ink layer 210 is optionally disposed on the first major surface of the paper substrate 212 and a moisture barrier layer 228 is optionally disposed on the exterior facing surface of the printed ink layer 210.

The packaging structure 200a differs from the packaging structure 100a shown and described above by way of reference to FIG. 1A in that the primer layer 120 is omitted and is replaced with a surface treatment or surface modification 236 on the interior facing surface of the barrier paper layer 208a. Exemplary surface treatments or modifications include flame treatment using a flame treater, corona treatment using a corona treater, plasma treatment using a plasma treater, or ozone treatment using an ozone treater. In preferred embodiments, the treated surface 236 is a flame treated surface. Otherwise, the description above of the structure 100a appearing in FIG. 1A is equally applicable to the structure 200a appearing in FIG. 2A.

Referring now to FIG. 2B, there is shown a packaging structure 200b comprising a first ply 204a having a dried polymer dispersion layer 232 on an interior facing surface thereof. The first ply 204a includes a barrier coated paper layer 208a. The barrier coated paper layer 208a comprises a paper substrate 212 having a first major surface which is exterior facing and a second major surface opposite the first major surface and a barrier layer 216 formed on the second major surface of the paper substrate 212.

In embodiments, a printed ink layer 210 is optionally disposed on the first major surface of the paper substrate 212. In embodiments, a moisture barrier layer 228 is optionally disposed on the first major surface of the paper substrate 212. In embodiments, a printed ink layer 210 is optionally disposed on the first major surface of the paper substrate 212 and a moisture barrier layer 228 is optionally disposed on the exterior facing surface of the printed ink layer 210.

The packaging structure 200b differs from the packaging structure 100b shown and described above by way of reference to FIG. 1B in that the primer layer 120 is omitted and is replaced with a surface treatment or surface modification 236 on the interior facing surface of the barrier paper layer 208a. Exemplary surface treatments or modifications include flame treatment using a flame treater, corona treatment using a corona treater, plasma treatment using a plasma treater, or ozone treatment using an ozone treater. In preferred embodiments, the treated surface 236 is a flame treated surface. Otherwise, the description above of the structure 100b appearing in FIG. 1B is equally applicable to the structure 200b appearing in FIG. 2B.

Referring now to FIG. 2C, there is shown a packaging structure 200c comprising a first ply 204c having an extrusion coated polymer layer 224 on an interior facing surface thereof. The first ply 204c includes a barrier coated paper layer 208c. The barrier coated paper layer 208c comprises a paper substrate 212 having a first major surface which is exterior facing and a second major surface opposite the first major surface and a barrier layer 216 formed on the first major surface of the paper substrate 212.

In embodiments, a printed ink layer 210 is optionally disposed on the first major surface of the paper substrate 212. In embodiments, a moisture barrier layer 228 is optionally disposed on the first major surface of the paper substrate 212. In embodiments, a printed ink layer 210 is optionally disposed on the first major surface of the paper substrate 212 and a moisture barrier layer 228 is optionally disposed on the exterior facing surface of the printed ink layer 210.

The packaging structure 200c differs from the packaging structure 100c shown and described above by way of reference to FIG. 1C in that the primer layer 120 is omitted and is replaced with a surface treatment or surface modification 236 on the second major surface of the paper layer 212. Exemplary surface treatments or modifications include flame treatment using a flame treater, corona treatment using a corona treater, plasma treatment using a plasma treater, or ozone treatment using an ozone treater. In preferred embodiments, the treated surface 236 is a flame treated surface. Otherwise, the description above of the structure 100c appearing in FIG. 1C is equally applicable to the structure 200c appearing in FIG. 2C.

Referring now to FIG. 2D, there is shown a packaging structure 200d comprising a first ply 204c having a dried polymer dispersion layer 224 on an interior facing surface thereof. The first ply 204c includes a barrier coated paper layer 208c. The barrier coated paper layer 208c comprises a paper substrate 212 having a first major surface which is exterior facing and a second major surface opposite the first major surface and a barrier layer 216 formed on the first major surface of the paper substrate 212.

In embodiments, a printed ink layer 210 is optionally disposed on the first major surface of the paper substrate 212. In embodiments, a moisture barrier layer 228 is optionally disposed on the first major surface of the paper substrate 212. In embodiments, a printed ink layer 210 is optionally disposed on the first major surface of the paper substrate 212 and a moisture barrier layer 228 is optionally disposed on the exterior facing surface of the printed ink layer 210.

The packaging structure 200d differs from the packaging structure 100d shown and described above by way of reference to FIG. 1D in that the primer layer 120 is omitted and is replaced with a surface treatment or surface modification 236 on the second major surface of the paper layer 212. Exemplary surface treatments or modifications include flame treatment using a flame treater, corona treatment using a corona treater, plasma treatment using a plasma treater, or ozone treatment using an ozone treater. In preferred embodiments, the treated surface 236 is a flame treated surface. Otherwise, the description above of the structure 100d appearing in FIG. 1D is equally applicable to the structure 200d appearing in FIG. 2D.

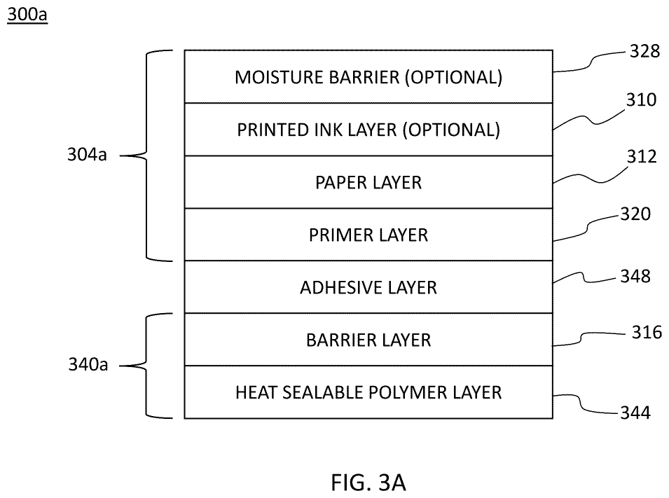

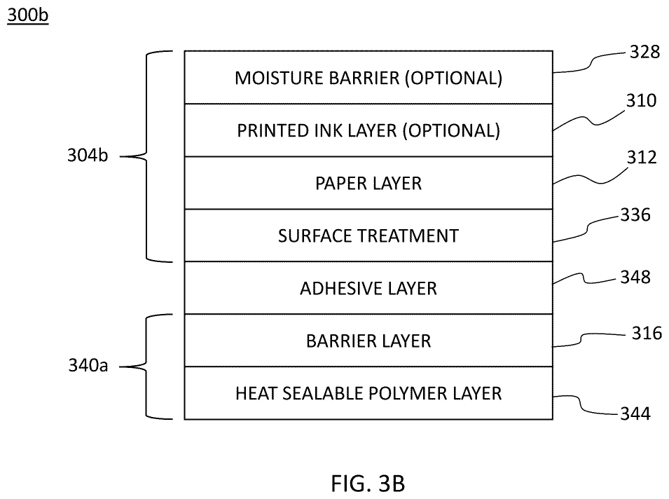

Referring now to FIG. 3A, there is shown a packaging structure 300a comprising a first ply 304a adhesively laminated to a second ply 340a. The first ply 304a includes a paper substrate 312, having a first major surface which is exterior facing and a second major surface opposite the second major surface. The paper substrate 312 may be formed of a paper material as described above.

In embodiments, a printed ink layer 310 is optionally disposed on the first major surface of the paper substrate 312. In embodiments, a moisture barrier layer 328 is optionally disposed on the first major surface of the paper substrate 312. In embodiments, a printed ink layer 310 is optionally disposed on the first major surface of the paper substrate 312 and a moisture barrier layer 328 is optionally disposed on the exterior facing surface of the printed ink layer 310. The printed ink layer 310 and the moisture barrier layer 328 may be as described above.

A primer layer 320 is disposed on the second major surface of the paper substrate 312 for promoting adhesion between the first ply 304a and the second ply 340a. The primer layer 320 may be as described above.

The second ply 340a comprises a heat scalable polymer layer 344 having a first major surface which is exterior facing and a second major surface opposite the first major surface. The second major surface of the heat sealable polymer layer 344 forms an innermost layer of the structure 300b. In operation, the second major surface of the heat scalable polymer layer 344 is heat sealable to itself and is configured to contact or face a product to be packaged in a finished packaging article, such as a bag or pouch.

In embodiments, the heat sealable polymer layer 344 is formed of a polyolefin-based polymer or copolymer material, preferably a polyethylene-based or polypropylene-based polymer material. In embodiments, the heat scalable polymer layer 344 may comprise a monomaterial or a blend. In certain embodiments, the heat scalable polymer layer 344 is formed of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), or blends thereof as well as coextrusions thereof.

In embodiments, the heat scalable polymer layer 344 is formed of a polyester-based material. In embodiments, the heat scalable polymer layer 344 is formed of a polyethylene terephthalate (PET).

In embodiments, the heat scalable polymer layer 344 is formed of oriented polymer film that has undergone orientation or stretching in the machine direction, transverse direction, or both. In embodiments, the heat scalable polymer layer 344 is formed of biaxially oriented polypropylene (BOPP), biaxially oriented polyethylene (BOPE), biaxially oriented polyethylene terephthalate (BOPET), biaxially oriented nylon, cast nylon, blown polypropylene, cast polypropylene, blown polyethylene, and cast polyethylene.

In embodiments, the heat scalable polymer layer 344 has a seal initiation temperature (SIT) in the range of 200° F. to 350° F., In embodiments, the heat sealable polymer layer 344 has a SIT in the range of 225° F. to 325° F. In embodiments, the heat scalable polymer layer 344 has a SIT in the range of 250° F. to 300° F.

In embodiments, the heat sealable polymer layer 344 has a basis weight in the range of 1 #/ream to 10 #/ream, e.g., 1 #/ream, 2 #/ream, 3 #/ream, 4 #/ream, 5 #/ream, 6 #/ream, 7 #/ream, 8 #/ream, 9 #/ream, or 10 #/ream.

A barrier layer 316 is disposed on the first major surface of the heat scalable polymer layer 344 to form the second ply 340a. The barrier layer 316 may be as described above by way of reference to the barrier layers 116 and 216 as described above.

An adhesive layer 348 is disposed intermediate the first ply 304a and the second ply 340a and adhesively laminates or bonds the first ply 304a and the second ply 340a to form the structure 300a. The adhesive layer 348 may be formed of any suitable adhesive including single component adhesives, two component adhesives, solvent-based adhesives, solventless adhesives, water-based adhesives, acrylic adhesives, electron beam lamination adhesives, and UV lamination adhesives, as would be understood by persons skilled in the art.

In embodiments, the adhesive layer 348 is formed of a biodegradable or compostable adhesive. In embodiments, the adhesive layer 348 is formed of a conventional a non-biodegradable or non-compostable adhesive. In embodiments, the amount of adhesive is present in the range of 0.1-10% by weight of the final structure, and more preferably 0.1 to 1% by weight of the final structure.

Referring now to FIG. 3B, there is shown a packaging structure 300b comprising a first ply 304b and a second ply 340a. The first ply 304b and second ply 340a are adhesively laminated via an adhesive layer 348. The first ply 304b includes a paper substrate 312, having a first major surface which is exterior facing and a second major surface opposite the second major surface. The paper substrate 312 may be formed of a paper material as described above. The second ply 340a and adhesive layer 348 may be as described above by way of reference to FIG. 3A.

In embodiments, a printed ink layer 310 is optionally disposed on the first major surface of the paper substrate 312. In embodiments, a moisture barrier layer 328 is optionally disposed on the first major surface of the paper substrate 312. In embodiments, a printed ink layer 310 is optionally disposed on the first major surface of the paper substrate 312 and a moisture barrier layer 328 is optionally disposed on the exterior facing surface of the printed ink layer 310. The printed ink layer 310 and the moisture barrier layer 328 may be as described above.

The packaging structure 300b differs from the packaging structure 300a shown and described above by way of reference to FIG. 3A in that the primer layer 320 is omitted and is replaced with a surface treatment or surface modification 336 on the interior facing surface of the paper layer 312. Exemplary surface treatments or modifications include flame treatment using a flame treater, corona treatment using a corona treater, plasma treatment using a plasma treater, or ozone treatment using an ozone treater. In preferred embodiments, the treated surface 336 is a flame treated surface. Otherwise, the description above of the structure 300b appearing in FIG. 3B is equally applicable to the structure 300b appearing in FIG. 3B.

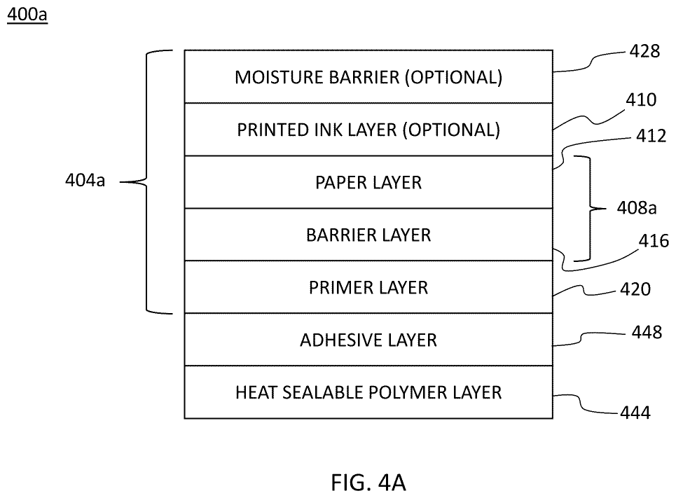

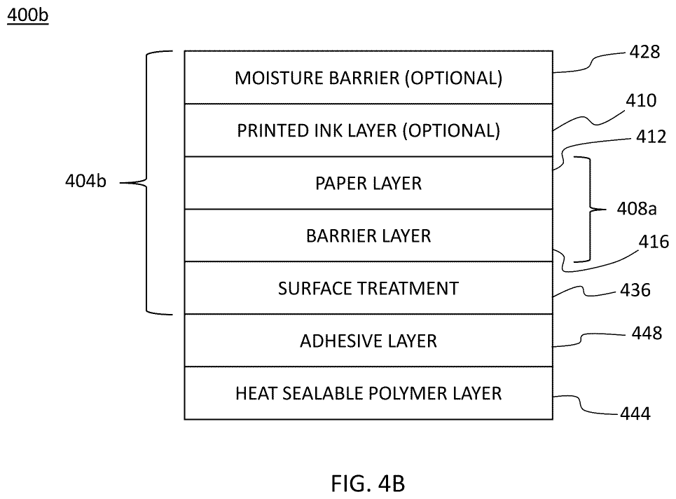

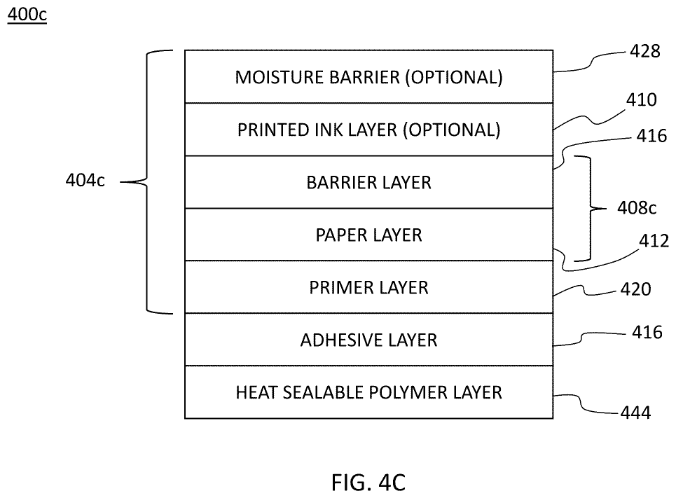

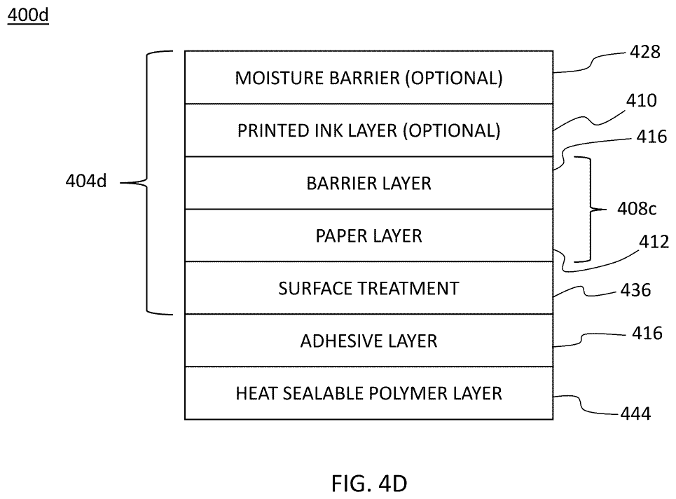

Referring now to FIG. 4A, there is shown a packaging structure 400a comprising a first ply 404a having a heat scalable polymer layer 444 adhesively laminated to an interior facing surface thereof via an adhesive layer 448. The first ply 404a includes a barrier coated paper layer 408a. The barrier coated paper layer 408a comprises a paper substrate 412 having a first major surface which is exterior facing and a second major surface opposite the first major surface and a barrier layer 416 formed on the second major surface of the paper substrate 412.

In embodiments, a printed ink layer 410 is optionally disposed on the first major surface of the paper substrate 412. In embodiments, a moisture barrier layer 428 is optionally disposed on the first major surface of the paper substrate 412. In embodiments, a printed ink layer 410 is optionally disposed on the first major surface of the paper substrate 212 and a moisture barrier layer 428 is optionally disposed on the exterior facing surface of the printed ink layer 410.

The packaging structure 400a differs from the packaging structure 100a shown and described above by way of reference to FIG. 1A in that extrusion coated layer 124 is omitted and is replaced with the adhesive layer 348 and the adhesively laminated heat scalable polymer layer 444. Otherwise, the description above of the structure 100a appearing in FIG. 1A is equally applicable to the structure 400a appearing in FIG. 4A.

Referring now to FIG. 4B, there is shown a packaging structure 400b comprising a first ply 404b having a heat sealable polymer layer 444 adhesively laminated to an interior facing surface thereof via an adhesive layer 448. The first ply 404b includes a barrier coated paper layer 408a. The barrier coated paper layer 408a comprises a paper substrate 412 having a first major surface which is exterior facing and a second major surface opposite the first major surface and a barrier layer 416 formed on the second major surface of the paper substrate 412.

In embodiments, a printed ink layer 410 is optionally disposed on the first major surface of the paper substrate 412. In embodiments, a moisture barrier layer 428 is optionally disposed on the first major surface of the paper substrate 412. In embodiments, a printed ink layer 410 is optionally disposed on the first major surface of the paper substrate 212 and a moisture barrier layer 428 is optionally disposed on the exterior facing surface of the printed ink layer 410.

The packaging structure 400b differs from the packaging structure 400a shown and described above by way of reference to FIG. 4A in that the primer layer 420 is omitted and is replaced with a surface treatment or surface modification 436 on the interior facing surface of the barrier paper layer 408a. Exemplary surface treatments or modifications include flame treatment using a flame treater, corona treatment using a corona treater, plasma treatment using a plasma treater, or ozone treatment using an ozone treater. In preferred embodiments, the treated surface 436 is a flame treated surface. Otherwise, the description above of the structure 400a appearing in FIG. 4A is equally applicable to the structure 400b appearing in FIG. 4B.

Referring now to FIG. 4C, there is shown a packaging structure 400c comprising a first ply 404c having a heat sealable polymer layer 444 adhesively laminated to an interior facing surface thereof via an adhesive layer 448. The first ply 404c includes a barrier coated paper layer 408c. The barrier coated paper layer 408c comprises a paper substrate 412 having a first major surface which is exterior facing and a second major surface opposite the first major surface and a barrier layer 416 formed on the first major surface of the paper substrate 412.

In embodiments, a printed ink layer 410 is optionally disposed on the first major surface of the paper substrate 412. In embodiments, a moisture barrier layer 428 is optionally disposed on the first major surface of the paper substrate 412. In embodiments, a printed ink layer 410 is optionally disposed on the first major surface of the paper substrate 412 and a moisture barrier layer 428 is optionally disposed on the exterior facing surface of the printed ink layer 410.

The packaging structure 400c differs from the packaging structure 400a shown and described above by way of reference to FIG. 4A in that the barrier layer 416 is disposed on the first major surface of the paper layer 412 and the primer layer 420 is in direct contact with the second major surface of the paper layer 412 . . . . Otherwise, the description above of the structure 400a appearing in FIG. 4A is equally applicable to the structure 400c appearing in FIG. 4C.

Referring now to FIG. 4D, there is shown a packaging structure 400d comprising a first ply 404d having a heat sealable polymer layer 444 adhesively laminated to an interior facing surface thereof via an adhesive layer 448. The first ply 404d includes a barrier coated paper layer 408c. The barrier coated paper layer 408c comprises a paper substrate 412 having a first major surface which is exterior facing and a second major surface opposite the first major surface and a barrier layer 416 formed on the first major surface of the paper substrate 412.

In embodiments, a printed ink layer 410 is optionally disposed on the first major surface of the paper substrate 412. In embodiments, a moisture barrier layer 428 is optionally disposed on the first major surface of the paper substrate 412. In embodiments, a printed ink layer 410 is optionally disposed on the first major surface of the paper substrate 212 and a moisture barrier layer 428 is optionally disposed on the exterior facing surface of the printed ink layer 410.

The packaging structure 400d differs from the packaging structure 400c shown and described above by way of reference to FIG. 4C in that the primer layer 420 is omitted and is replaced with a surface treatment or surface modification 436 on the interior facing surface of the barrier paper layer 408c. Exemplary surface treatments or modifications include flame treatment using a flame treater, corona treatment using a corona treater, plasma treatment using a plasma treater, or ozone treatment using an ozone treater. In preferred embodiments, the treated surface 436 is a flame treated surface. Otherwise, the description above of the structure 400c appearing in FIG. 4C is equally applicable to the structure 400d appearing in FIG. 4D.

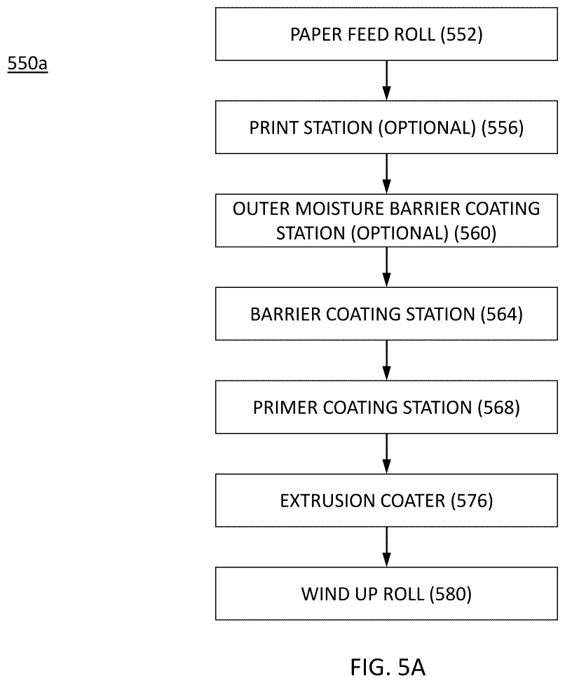

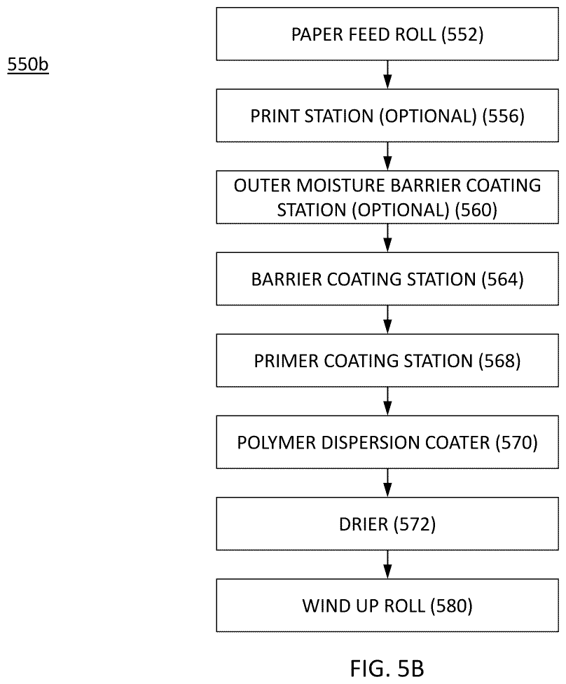

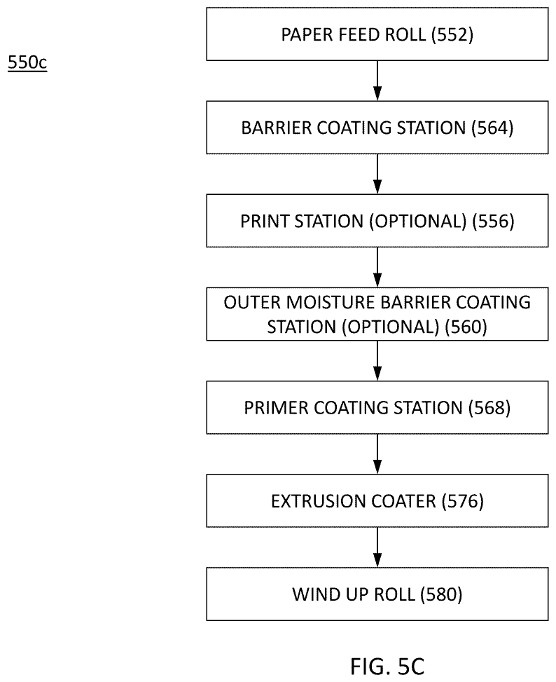

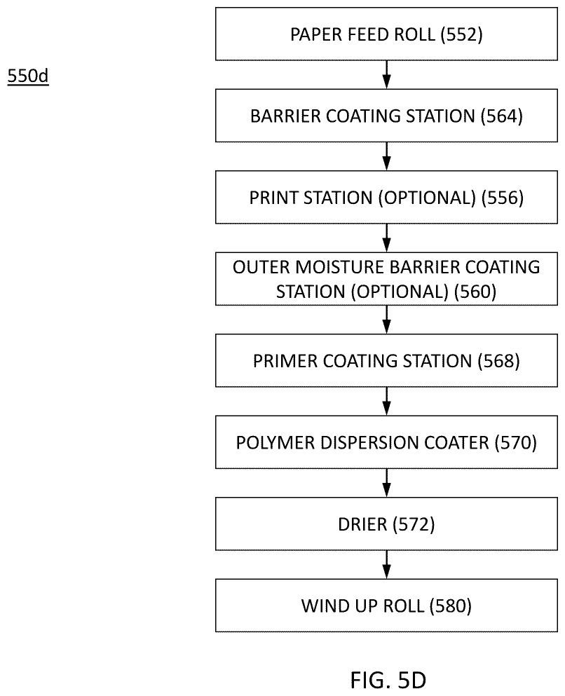

Referring now to FIG. 5A, there is shown an exemplary process line or method 550a for the manufacture of the packaging structure 100a appearing in FIG. 1A. The paper substrate 112 is unwound from a feed roll 552 and optionally fed to a print station 556 for printing the printed indicia layer 110 on the first major surface of the paper substrate 112. The paper substrate 112 is then optionally fed to a coating station 560 for coating with the moisture barrier layer 128.

The paper substrate 112 (with optional printed ink layer 110 and/or optional moisture barrier layer 128) is then fed to a barrier coating station 564 for application of the barrier layer 116 to the second major surface of the paper substrate 112 to form the barrier coated paper 108a. The barrier coated substrate 108a is then fed to a primer coating station 568 for application of the primer layer 120 to the barrier layer 116 to form the first ply 104a. The first ply 104a is then fed to an extrusion coater 576 wherein the extrusion coated polymer layer 124 is brought on to the primer layer 120 as a melt curtain and cooled or chilled, e.g., with a chill roll, allowing the extrusion coated polymer layer 124 to adhere to the primer layer 120 to form the structure 100a.

The structure 100a is then fed to a wind up roll 580. It will be recognized that the order of steps may be varied. For example, in certain embodiments, the printed layer 110 may be pre-printed on the paper substrate; in certain embodiments, the printed layer 110 may be pre-printed on the paper substrate and the moisture barrier layer 128 may be pre-applied to the paper substrate; in certain embodiments, the barrier layer 116 may be preapplied to the paper substrate; in certain embodiments, the barrier layer 116 and primer layer 120 may be preapplied to the paper substrate.

Referring now to FIG. 5B, there is shown an exemplary process line or method 550b for the manufacture of the packaging structure 100b appearing in FIG. 1B. The paper substrate 112 is unwound from a feed roll 552 and optionally fed to a print station 556 for printing the printed indicia layer 110 on the first major surface of the paper substrate 112. The paper substrate 112 is then optionally fed to a coating station 560 for coating with the moisture barrier layer 128.

The paper substrate 112 (with optional printed ink layer 110 and/or optional moisture barrier layer 128) is then fed to a barrier coating station 564 for application of the barrier layer 116 to the second major surface of the paper substrate 112 to form the barrier coated paper 108a. The barrier coated substrate 108a is then fed to a primer coating station 568 for application of the primer layer 120 to the barrier layer 116 to form the first ply 104a. The first ply 104a is then fed to a polymer dispersion coater 570 wherein a colloidal dispersion is coated onto the primer layer 120. The coated ply is then fed to a drier 572 wherein the liquid/solvent is removed from the wet polymer dispersion to form the structure 100b.

The structure 100b is then fed to a wind up roll 580. It will be recognized that the order of steps may be varied. For example, in certain embodiments, the printed layer 110 may be pre-printed on the paper substrate; in certain embodiments, the printed layer 110 may be pre-printed on the paper substrate and the moisture barrier layer 128 may be pre-applied to the paper substrate; in certain embodiments, the barrier layer 116 may be preapplied to the paper substrate; in certain embodiments, the barrier layer 116 and primer layer 120 may be preapplied to the paper substrate.

Referring now to FIG. 5C, there is shown an exemplary process line or method 550c for the manufacture of the packaging structure 100c appearing in FIG. 1C. The paper substrate 112 is unwound from a feed roll 552 and fed to a barrier coating station 564 for application of the barrier layer 116 to the first major surface of the paper substrate 112 to form the barrier coated paper 108c. The barrier coated paper 108c is optionally fed to a print station 556 for printing the printed indicia layer 110 on the first major surface of the paper substrate 112. The barrier coated paper 108c is then optionally fed to a coating station 560 for coating with the moisture barrier layer 128.

The barrier coated substrate 108c (with optional printed ink layer 110 and/or optional moisture barrier layer 128) is then fed to a primer coating station 568 for application of the primer layer 120 to the second major surface of the paper layer 112 to form the first ply 104c. The first ply 104c is then fed to an extrusion coater 576 wherein the extrusion coated polymer layer 124 is brought on to the primer layer 120 as a melt curtain and cooled or chilled, e.g., with a chill roll, allowing the extrusion coated polymer layer 124 to adhere to the primer layer 120 to form the structure 100c.

The structure 100c is then fed to a wind up roll 580. It will be recognized that the order of steps may be varied. For example, in certain embodiments, the barrier layer 116 may be pre-applied to the paper substrate; in embodiments the barrier layer 116 and the primer layer 120 may be pre-applied to the paper substrate; in embodiments, the barrier layer 116 and printed ink layer 110 may be pre-applied to the paper substrate; in embodiments, the barrier layer 116, printed ink layer 110, and the moisture barrier layer 128 may be pre-applied to the paper substrate.

Referring now to FIG. 5D, there is shown an exemplary process line or method 550d for the manufacture of the packaging structure 100d appearing in FIG. 1D. The paper substrate 112 is unwound from a feed roll 552 and fed to a barrier coating station 564 for application of the barrier layer 116 to the first major surface of the paper substrate 112 to form the barrier coated paper 108c. The barrier coated paper 108c is optionally fed to a print station 556 for printing the printed indicia layer 110 on the first major surface of the paper substrate 112. The barrier coated paper 108c is then optionally fed to a coating station 560 for coating with the moisture barrier layer 128.

The barrier coated substrate 108c (with optional printed ink layer 110 and/or optional moisture barrier layer 128) is then fed to a primer coating station 568 for application of the primer layer 120 to the second major surface of the paper layer 112 to form the first ply 104c. The first ply 104c is then fed to a polymer dispersion coater 570 wherein a colloidal dispersion is coated onto the primer layer 120. The coated ply is then fed to a drier 572 wherein the liquid/solvent is removed from the wet polymer dispersion to form the structure 100d.

The structure 100d is then fed to a wind up roll 580. It will be recognized that the order of steps may be varied. For example, in certain embodiments, the barrier layer 116 may be pre-applied to the paper substrate; in embodiments the barrier layer 116 and the primer layer 120 may be pre-applied to the paper substrate; in embodiments, the barrier layer 116 and printed ink layer 110 may be pre-applied to the paper substrate; in embodiments, the barrier layer 116, printed ink layer 110, and the moisture barrier layer 128 may be pre-applied to the paper substrate.

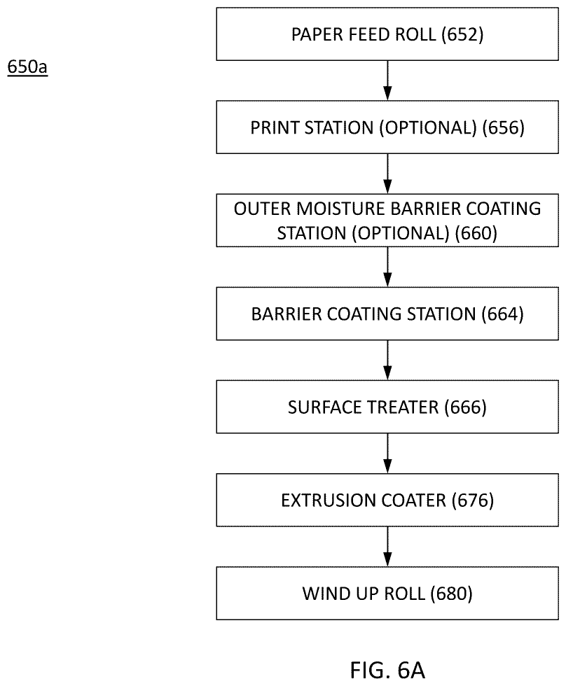

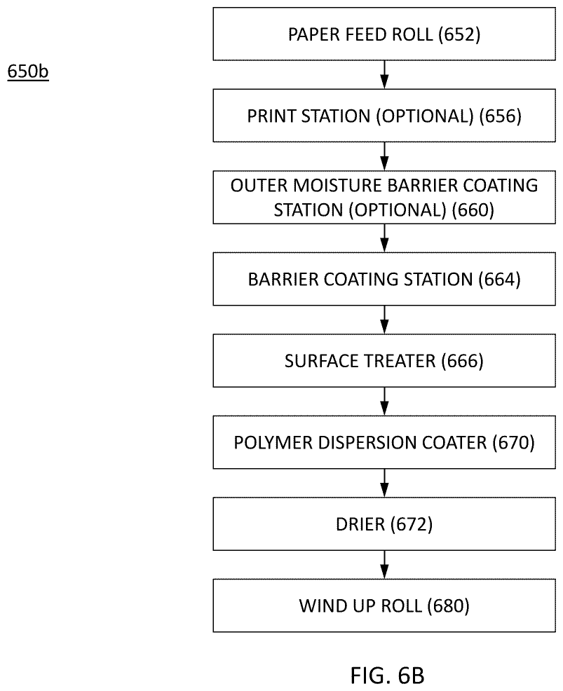

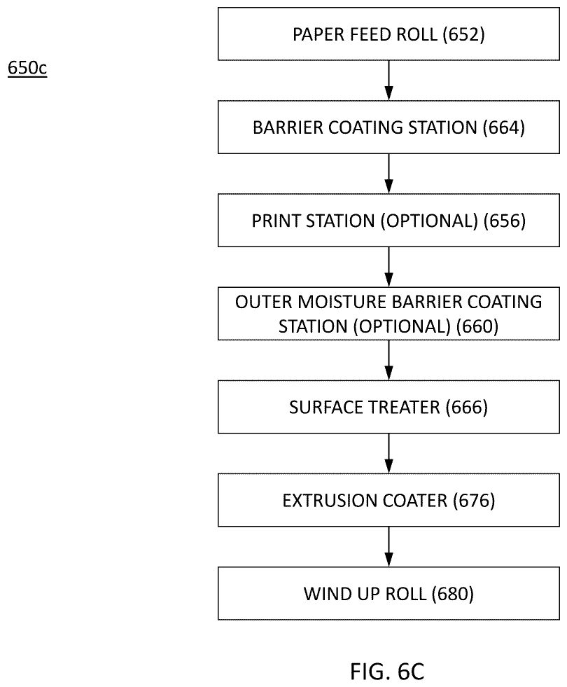

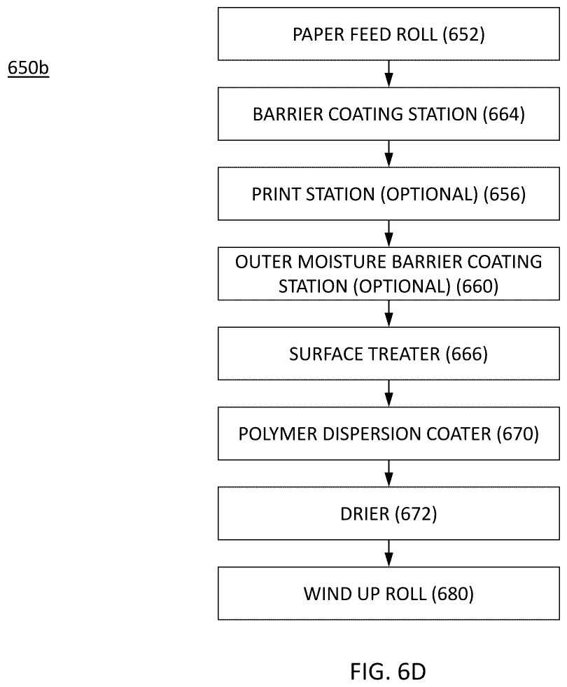

Referring now to FIG. 6A, there is shown an exemplary process line or method 650a for the manufacture of the packaging structure 200a appearing in FIG. 2A. The paper substrate 212 is unwound from a feed roll 652 and optionally fed to a print station 656 for printing the printed indicia layer 210 on the first major surface of the paper substrate 212. The paper substrate 212 is then optionally fed to a coating station 660 for coating with the moisture barrier layer 228.

The paper substrate 212 (with optional printed ink layer 210 and/or optional moisture barrier layer 228) is then fed to a barrier coating station 664 for application of the barrier layer 216 to the second major surface of the paper substrate 212 to form the barrier coated paper 208a. The barrier coated substrate 208a is then fed to a surface treater 666 for surface modification of the inward facing surface of the barrier coated paper 208a to form the first ply 204a and promote adhesion between the first ply 204a and the extrusion coated polymer layer 224. The first ply 204a is then fed to an extrusion coater 676 wherein the extrusion coated polymer layer 224 is brought on to the treated surface of the first ply 204a as a melt curtain and cooled or chilled, e.g., with a chill roll, allowing the extrusion coated polymer layer 224 to adhere to the treated to form the structure 200a.

The structure 200a is then fed to a wind up roll 680. It will be recognized that the order of steps may be varied. For example, in certain embodiments, the printed layer 210 may be pre-printed on the paper substrate; in certain embodiments, the printed layer 210 may be pre-printed on the paper substrate and the moisture barrier layer 228 may be pre-applied to the paper substrate; in certain embodiments, the barrier layer 216 may be preapplied to the paper substrate.

Referring now to FIG. 6B, there is shown an exemplary process line or method 650b for the manufacture of the packaging structure 200b appearing in FIG. 2B. The paper substrate 212 is unwound from a feed roll 652 and optionally fed to a print station 656 for printing the printed indicia layer 210 on the first major surface of the paper substrate 212. The paper substrate 212 is then optionally fed to a coating station 660 for coating with the moisture barrier layer 228.

The paper substrate 212 (with optional printed ink layer 210 and/or optional moisture barrier layer 228) is then fed to a barrier coating station 664 for application of the barrier layer 216 to the second major surface of the paper substrate 212 to form the barrier coated paper 208a. The barrier coated substrate 208a is then fed to a surface treater 666 for surface modification of the inward facing surface of the barrier coated paper 208a to form the first ply 204a and promote adhesion between the first ply 204a and the polymer dispersion layer 232. The first ply 204a is then fed to a polymer dispersion coater 570 wherein a colloidal dispersion is coated onto the treated surface 236. The coated ply is then fed to a drier 572 wherein the liquid/solvent is removed from the wet polymer dispersion to form the structure 200b.

The structure 200b is then fed to a wind up roll 680. It will be recognized that the order of steps may be varied. For example, in certain embodiments, the printed layer 210 may be pre-printed on the paper substrate; in certain embodiments, the printed layer 210 may be pre-printed on the paper substrate and the moisture barrier layer 228 may be pre-applied to the paper substrate; in certain embodiments, the barrier layer 216 may be preapplied to the paper substrate; in certain embodiments.

Referring now to FIG. 6C, there is shown an exemplary process line or method 650c for the manufacture of the packaging structure 600c appearing in FIG. 2C. The paper substrate 212 is unwound from a feed roll 652 and fed to a barrier coating station 664 for application of the barrier layer 216 to the first major surface of the paper substrate 212 to form the barrier coated paper 208c. The barrier coated paper 208c is optionally fed to a print station 656 for printing the printed indicia layer 210 on the first major surface of the paper substrate 212. The barrier coated paper 208c is then optionally fed to a coating station 660 for coating with the moisture barrier layer 228.

The barrier coated substrate 208c (with optional printed ink layer 210 and/or optional moisture barrier layer 228) is then fed to a surface treater 666 for surface modification of the second major surface of the paper layer 212 to form the first ply 204c and promote adhesion between the first ply 204c and the extrusion coated polymer layer 224. The first ply 204c is then fed to an extrusion coater 676 wherein the extrusion coated polymer layer 224 is brought on to the treated surface 236 as a melt curtain and cooled or chilled, e.g., with a chill roll, allowing the extrusion coated polymer layer 224 to adhere to the treated surface 236 to form the structure 200c.

The structure 200c is then fed to a wind up roll 580. It will be recognized that the order of steps may be varied. For example, in certain embodiments, the barrier layer 216 may be pre-applied to the paper substrate; in embodiments, the barrier layer 216 and printed ink layer 210 may be pre-applied to the paper substrate; in embodiments, the barrier layer 216, printed ink layer 210, and the moisture barrier layer 228 may be pre-applied to the paper substrate.

Referring now to FIG. 6D, there is shown an exemplary process line or method 650d for the manufacture of the packaging structure 200d appearing in FIG. 2D. The paper substrate 212 is unwound from a feed roll 652 and fed to a barrier coating station 664 for application of the barrier layer 216 to the first major surface of the paper substrate 212 to form the barrier coated paper 208c. The barrier coated paper 208c is optionally fed to a print station 656 for printing the printed indicia layer 210 on the first major surface of the paper substrate 212. The barrier coated paper 208c is then optionally fed to a coating station 660 for coating with the moisture barrier layer 228.

The barrier coated substrate 208c (with optional printed ink layer 210 and/or optional moisture barrier layer 228) is then fed to a surface treater 666 for surface modification of the second major surface of the paper layer 212 to form the first ply 204c and promote adhesion between the first ply 204c and the dried polymer dispersion layer 232. The first ply 204c is then fed to a polymer dispersion coater 670 wherein a colloidal dispersion is coated onto the treated surface 236. The coated ply is then fed to a drier 672 wherein the liquid/solvent is removed from the wet polymer dispersion to form the structure 200d.

The structure 200d is then fed to a wind up roll 680. It will be recognized that the order of steps may be varied. For example, in certain embodiments, the barrier layer 216 may be pre-applied to the paper substrate; in embodiments, the barrier layer 216 and printed ink layer 210 may be pre-applied to the paper substrate; in embodiments, the barrier layer 216, printed ink layer 210, and the moisture barrier layer 228 may be pre-applied to the paper substrate.

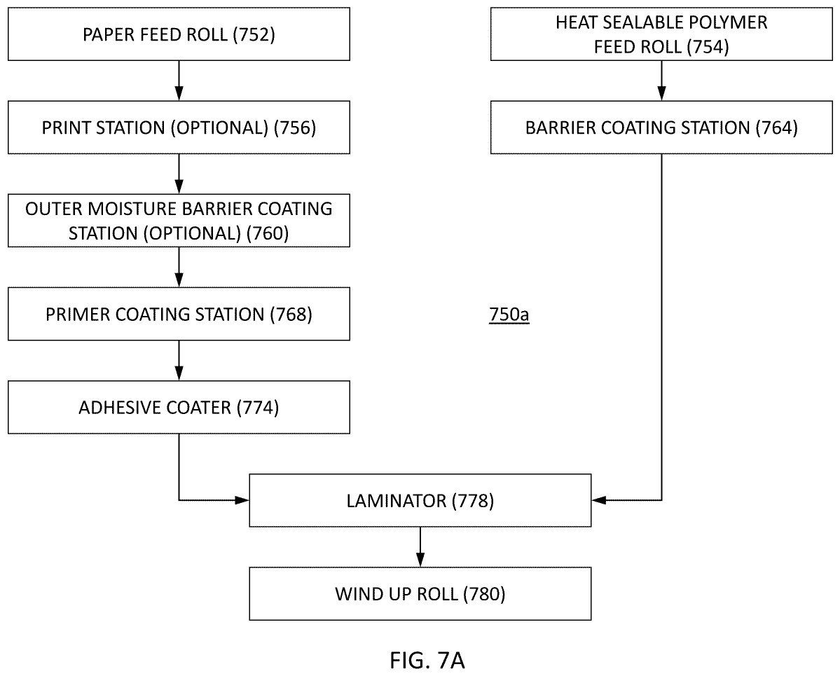

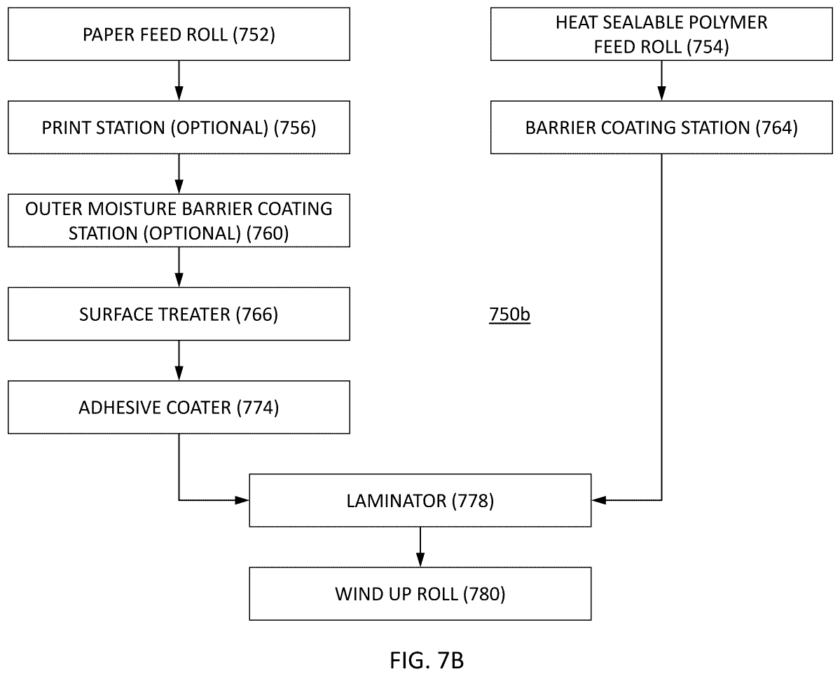

Referring now to FIG. 7A, there is shown an exemplary process line or method 750a for the manufacture of the packaging structure 300a appearing in FIG. 3A. The paper substrate 312 is unwound from a feed roll 752 and optionally fed to a print station 756 for printing the printed indicia layer 310 on the first major surface of the paper substrate 312. The paper substrate 312 is then optionally fed to a coating station 760 for coating with the moisture barrier layer 328.

The paper substrate 312 (with optional printed ink layer 310 and/or optional moisture barrier layer 328) is then fed to a primer coating station 768 for application of the primer layer 320 to the second major surface of the paper substrate 312 to form the first ply 304a. The first ply 304a is then fed to an adhesive coater 774 wherein the adhesive coating layer 348 is applied over the primer layer 320.

Meanwhile, a web of heat scalable polymer 344 is fed from a feed roll 754 and fed to a barrier coating station 764 for application of the barrier layer 316 to the first major surface of the web 344 to form the second ply 340a.

The adhesive coated first ply 304a and second ply 340a are fed to a laminating station 778 and pressed together to form the bonded laminate 300a. The structure 300a is then fed to a wind up roll 780. It will be recognized that the order of steps may be varied. For example, in certain embodiments, the printed layer 310 may be pre-printed on the paper substrate; in certain embodiments, the printed layer 310 may be pre-printed on the paper substrate and the moisture barrier layer 328 may be pre-applied to the paper substrate; in certain embodiments, the barrier layer 316 may be pre-applied to the web 344; in certain embodiments, the primer layer 320 may be preapplied to the paper substrate. In certain embodiments, the adhesive 348 may be coated onto the second ply 340a. In certain embodiments, the adhesive is not precoated onto one of the plies 304a, 340a, but is extruded into the nip before the two plies meet to form an extrusion lamination.

Referring now to FIG. 7B, there is shown an exemplary process line or method 750b for the manufacture of the packaging structure 300b appearing in FIG. 3B. The paper substrate 312 is unwound from a feed roll 752 and optionally fed to a print station 756 for printing the printed indicia layer 310 on the first major surface of the paper substrate 312. The paper substrate 312 is then optionally fed to a coating station 760 for coating with the moisture barrier layer 328.

The paper substrate 312 (with optional printed ink layer 310 and/or optional moisture barrier layer 328) is then fed to a surface treater 766 for surface treatment/modification of the second major surface of the paper substrate 312 to form the first ply 304b. The first ply 304b is then fed to an adhesive coater 774 wherein the adhesive coating layer 348 is applied over the treated surface 336.

Meanwhile, a web of heat sealable polymer 344 is fed from a feed roll 754 and

fed to a barrier coating station 764 for application of the barrier layer 316 to the first major surface of the web 344 to form the second ply 340a.

The adhesive coated first ply 304b and second ply 340a are fed to a laminating station 778 and pressed together to form the bonded laminate 300b. The structure 300b is then fed to a wind up roll 780. It will be recognized that the order of steps may be varied. For example, in certain embodiments, the printed layer 310 may be pre-printed on the paper substrate; in certain embodiments, the printed layer 310 may be pre-printed on the paper substrate and the moisture barrier layer 328 may be pre-applied to the paper substrate; in certain embodiments, the barrier layer 316 may be pre-applied to the web 344. In certain embodiments, the adhesive 348 may be coated onto the second ply 340a. In certain embodiments, the adhesive is not precoated onto one of the plies 304b, 340a, but is extruded into the nip before the two plies meet to form an extrusion lamination.

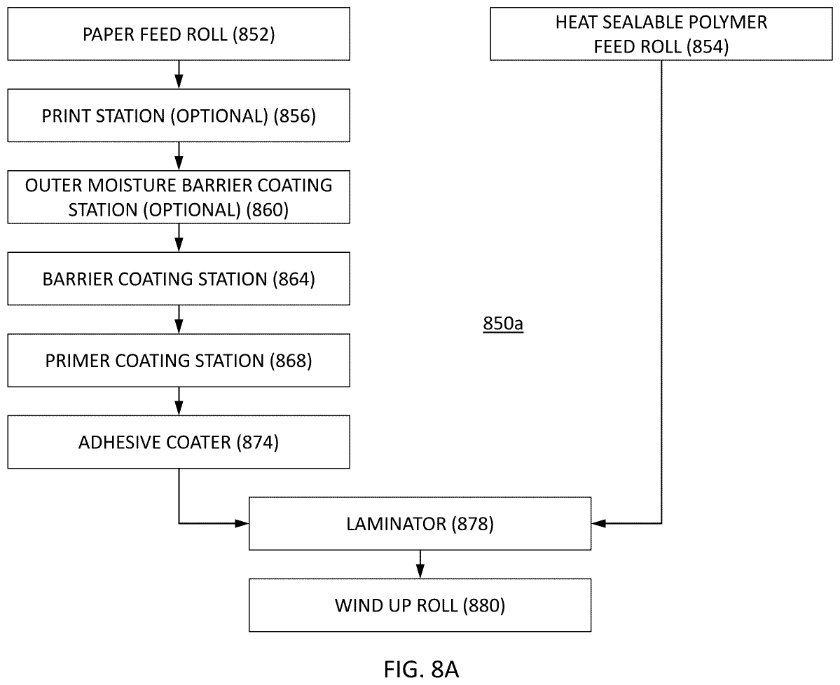

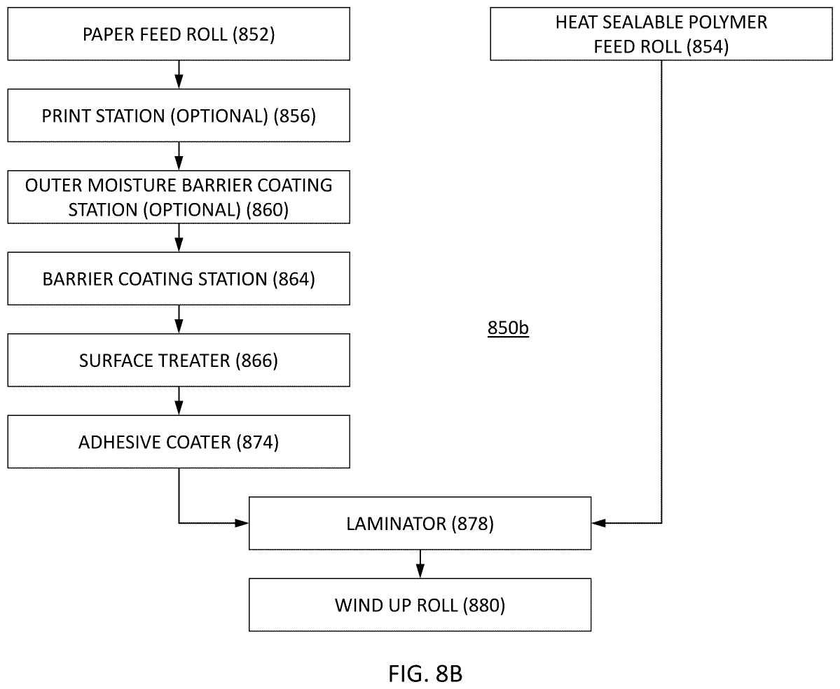

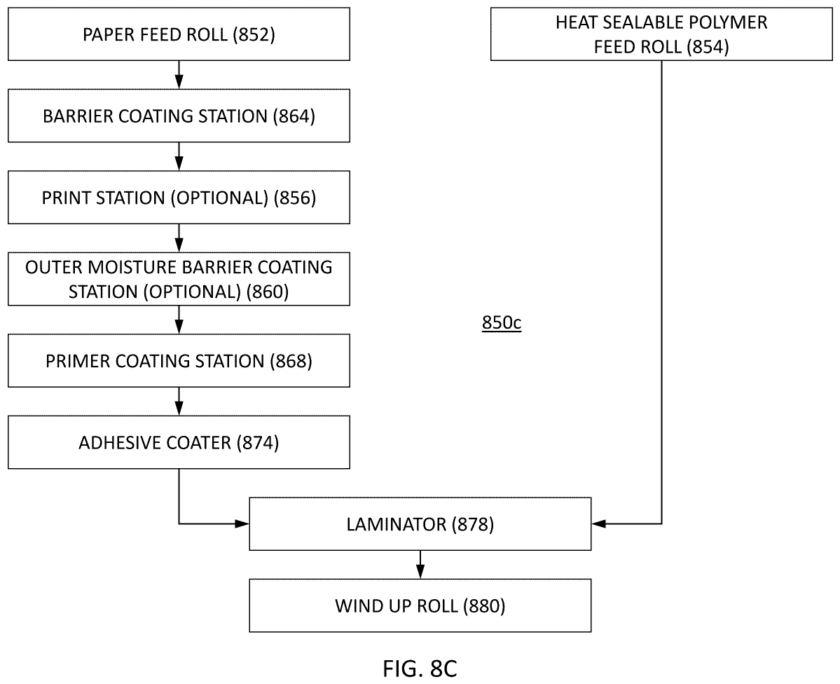

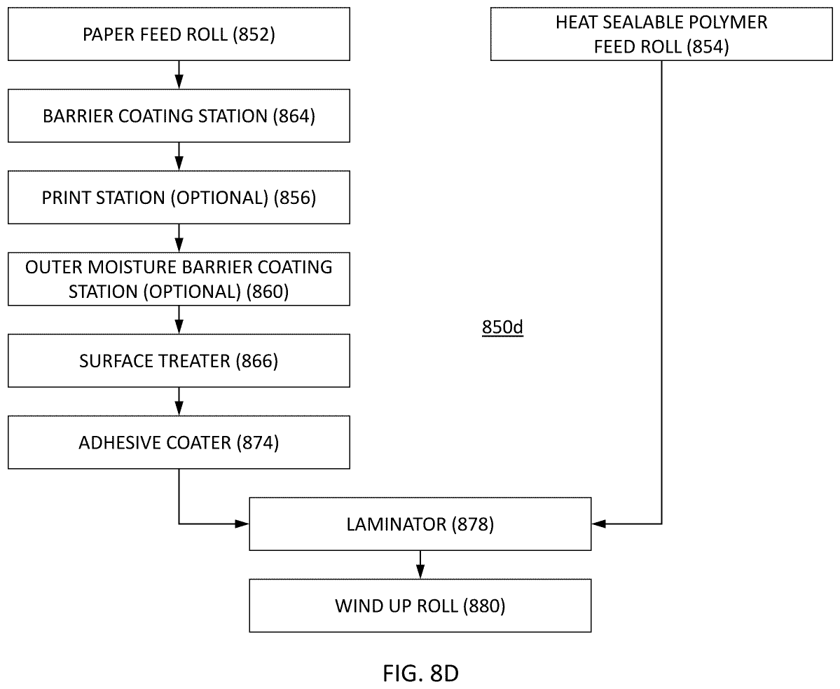

Referring now to FIG. 8A, there is shown an exemplary process line or method 850a for the manufacture of the packaging structure 400a appearing in FIG. 4A. The paper substrate 412 is unwound from a feed roll 852 and optionally fed to a print station 856 for printing the printed indicia layer 410 on the first major surface of the paper substrate 412. The paper substrate 412 is then optionally fed to a coating station 860 for coating with the moisture barrier layer 428.

The paper substrate 412 (with optional printed ink layer 410 and/or optional moisture barrier layer 428) is then fed to a barrier coating station 864 for application of the barrier layer 416 to the second major surface of the paper substrate 412. The barrier coated paper 408a (with optional printed ink layer 410 and/or optional moisture barrier layer 428) is then fed to a primer coating station 868 for application of the primer layer 420 to the barrier coating 416 to form the first ply 404a. The first ply 404a is then fed to an adhesive coater 874 wherein the adhesive coating layer 448 is applied over the primer layer 420. The adhesive coated first ply 404a is then fed to a laminating station 878.

A web of heat scalable polymer 444 is fed from a feed roll 854 and fed to the laminating station 878 where it is pressed together with the adhesive coated first ply 404a to form the bonded laminate 400a. The structure 400a is then fed to a wind up roll 880.

It will be recognized that the order of steps may be varied. For example, in certain embodiments, the printed layer 410 may be pre-printed on the paper substrate; in certain embodiments, the printed layer 410 may be pre-printed on the paper substrate and the moisture barrier layer 428 may be pre-applied to the paper substrate; in certain embodiments, the barrier layer 416 may be pre-applied to the web 444; in certain embodiments, the primer layer 420 may be preapplied to the paper substrate. In certain embodiments, the adhesive 448 may be coated onto the web 444. In certain embodiments, the adhesive is not pre-coated onto one of the plies 404a, 444, but is extruded into the nip before the two plies meet to form an extrusion lamination.

Referring now to FIG. 8B, there is shown an exemplary process line or method 850b for the manufacture of the packaging structure 400b appearing in FIG. 4B. The paper substrate 412 is unwound from a feed roll 852 and optionally fed to a print station 856 for printing the printed indicia layer 410 on the first major surface of the paper substrate 412. The paper substrate 412 is then optionally fed to a coating station 860 for coating with the moisture barrier layer 428.

The paper substrate 412 (with optional printed ink layer 410 and/or optional moisture barrier layer 428) is then fed to a barrier coating station 864 for application of the barrier layer 416 to the second major surface of the paper substrate 412. The barrier coated paper 408a (with optional printed ink layer 410 and/or optional moisture barrier layer 428) is then fed to a surface treater 866 for surface treatment/modification of the second major surface of the paper substrate 412 to form the first ply 404b. The first ply 404b is then fed to an adhesive coater 874 wherein the adhesive coating layer 448 is applied over the treated surface 436. The adhesive coated first ply 404b is then fed to a laminating station 878.

A web of heat scalable polymer 444 is fed from a feed roll 854 and fed to the laminating station 878 where it is pressed together with the adhesive coated first ply 404b to form the bonded laminate 400b. The structure 400b is then fed to a wind up roll 880.

It will be recognized that the order of steps may be varied. For example, in certain embodiments, the printed layer 410 may be pre-printed on the paper substrate; in certain embodiments, the printed layer 410 may be pre-printed on the paper substrate and the moisture barrier layer 428 may be pre-applied to the paper substrate; in certain embodiments, the barrier layer 416 may be pre-applied to the web 444. In certain embodiments, the adhesive 448 may be coated onto the web 444. In certain embodiments, the adhesive is not pre-coated onto one of the plies 404b, 444, but is extruded into the nip before the two plies meet to form an extrusion lamination.

Referring now to FIG. 8C, there is shown an exemplary process line or method 850c for the manufacture of the packaging structure 400c appearing in FIG. 4C. The paper substrate 412 is unwound from a feed roll 852 and optionally fed to a print station 856 for printing the printed indicia layer 410 on the first major surface of the paper substrate 412. The paper substrate 412 is then optionally fed to a coating station 860 for coating with the moisture barrier layer 428.

The paper substrate 412 (with optional printed ink layer 410 and/or optional moisture barrier layer 428) is then fed to a barrier coating station 864 for application of the barrier layer 416 to the first major surface of the paper substrate 412. The barrier coated paper 408c (with optional printed ink layer 410 and/or optional moisture barrier layer 428) is then fed to a primer coating station 868 for application of the primer layer 420 to the second major surface of the paper substrate 412 to form the first ply 404c. The first ply 404c is then fed to an adhesive coater 874 wherein the adhesive coating layer 448 is applied over the primer layer 420. The adhesive coated first ply 404c is then fed to a laminating station 878.

A web of heat scalable polymer 444 is fed from a feed roll 854 and fed to the laminating station 878 where it is pressed together with the adhesive coated first ply 404c to form the bonded laminate 400c. The structure 400c is then fed to a wind up roll 880.

It will be recognized that the order of steps may be varied. For example, in certain embodiments, the printed layer 410 may be pre-printed on the paper substrate; in certain embodiments, the printed layer 410 may be pre-printed on the paper substrate and the moisture barrier layer 428 may be pre-applied to the paper substrate; in certain embodiments, the barrier layer 416 may be pre-applied to the web 444; in certain embodiments, the primer layer 420 may be preapplied to the paper substrate. In certain embodiments, the adhesive 448 may be coated onto the web 444. In certain embodiments, the adhesive is not pre-coated onto one of the plies 404c, 444, but is extruded into the nip before the two plies meet to form an extrusion lamination.

Referring now to FIG. 8D, there is shown an exemplary process line or method 850d for the manufacture of the packaging structure 400d appearing in FIG. 4D. The paper substrate 412 is unwound from a feed roll 852 and optionally fed to a print station 856 for printing the printed indicia layer 410 on the first major surface of the paper substrate 412. The paper substrate 412 is then optionally fed to a coating station 860 for coating with the moisture barrier layer 428.

The paper substrate 412 (with optional printed ink layer 410 and/or optional moisture barrier layer 428) is then fed to a barrier coating station 864 for application of the barrier layer 416 to the first major surface of the paper substrate 412. The barrier coated paper 408a (with optional printed ink layer 410 and/or optional moisture barrier layer 428) is then fed to a surface treater 866 for surface treatment/modification of the second major surface of the paper substrate 412 to form the first ply 404d. The first ply 404d is then fed to an adhesive coater 874 wherein the adhesive coating layer 448 is applied over the treated surface 436. The adhesive coated first ply 404d is then fed to a laminating station 878.

A web of heat sealable polymer 444 is fed from a feed roll 854 and fed to the laminating station 878 where it is pressed together with the adhesive coated first ply 404d to form the bonded laminate 400d. The structure 400d is then fed to a wind up roll 880.

It will be recognized that the order of steps may be varied. For example, in certain embodiments, the printed layer 410 may be pre-printed on the paper substrate; in certain embodiments, the printed layer 410 may be pre-printed on the paper substrate and the moisture barrier layer 428 may be pre-applied to the paper substrate; in certain embodiments, the barrier layer 416 may be pre-applied to the web 444. In certain embodiments, the adhesive 448 may be coated onto the web 444. In certain embodiments, the adhesive is not pre-coated onto one of the plies 404d, 444, but is extruded into the nip before the two plies meet to form an extrusion lamination.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A recyclable, paper-based composite film structure comprising:
a first ply comprising:
a paper substrate having a first major surface and a second major surface opposite the first major surface, the first major surface of the paper substrate configured to face away from a product to be packaged; and
a barrier layer disposed on one of the first major surface of the paper substrate and the second major surface of the paper substrate;
a heat sealable polymer layer having a first major surface and a second major surface opposite the first major surface, the first major surface of the heat sealable polymer layer configured to face toward the second major surface of the paper substrate and the second major surface of the heat sealable polymer layer configured to form an innermost surface of the recyclable, paper-based composite film structure; and
an adhesion promotor disposed intermediate the paper substrate and the heat sealable polymer layer.

2. The recyclable, paper-based composite film structure or claim 1, further comprising one or both of a moisture barrier layer and a printed ink layer disposed on the first major surface of the paper substrate.

3. The recyclable, paper-based composite film structure or claim 1, wherein the adhesion promotor is selected from the group consisting of a primer layer disposed intermediate the barrier layer and the heat sealable polymer layer and a modified surface of the first ply.

4. The recyclable, paper-based composite film structure or claim 3, wherein the modified surface is selected from the group consisting of a flame treated surface, a corona treated surface, a plasma treated surface, and an ozone treated surface.

5. The recyclable, paper-based composite film structure or claim 1, wherein the barrier layer is a moisture barrier, an oxygen barrier, or both.

6. The recyclable, paper-based composite film structure or claim 5, wherein the barrier layer is selected from the group consisting of ceramic coatings, inorganic oxide coatings, inorganic nitride coatings, inorganic carbide coatings, aluminum oxide coatings (AlOx), silicon oxide coatings (SiOx), blends of AlOx and SiOx, a metallization layer, an aluminum metallization layer, and polyvinyl alcohol (PVOH) coatings.

7. The recyclable, paper-based composite film structure or claim 5, wherein the recyclable, paper-based composite film structure has one or both of:
an oxygen transmission rate (OTR) in the range of 0.001 cc/100 in²/day to 5 cc/100 in²/day (when tested at 23° C. and 50% relative humidity); and
a water vapor transmission rate (WVTR) in the range of 0.001 cc/100 in²/day to cc/100 in² day (when tested at 23° C. and 85% relative humidity).

8. The recyclable, paper-based composite film structure or claim 1, wherein the heat sealable polymer layer is selected from the group consisting of an extrusion coated polymer layer and a dried polymer dispersion layer.

9. The recyclable, paper-based composite film structure or claim 1, further comprising an adhesive layer disposed intermediate the first ply and the heat sealable polymer, wherein the heat sealable polymer layer comprises a web laminated to an inward facing surface of the first ply.

10. The recyclable, paper-based composite film structure or claim 1, wherein the heat scalable polymer layer is formed of a material selected from the group consisting of polyolefin-based polymers, polyolefin-based copolymers, polyethylene-based polymers, polypropylene-based polymers, polypropylenes, high-density polyethylenes (HDPE), medium density polyethylenes (MDPE), linear medium density polyethylenes (LMDPE), low-density polyethylenes (LDPE), linear low-density polyethylenes (LLDPE), very low-density polyethylenes (VLDPE), metallocene linear low-density polyethylenes (mLLDPE), polyolefin plastomers (POP), acrylic polymers, acrylic copolymers, methacrylic acid (MAA) polymers, ethylene acrylic acid (EAA) polymers, ethylene-methacrylic acid (EMAA) copolymers, ethylene-methyl acrylate (EMA) copolymers, ethylene-methyl methacrylate (EMMA) copolymers, ethylene-ethyl acrylate (EEA) copolymers, ethylene-butyl acrylate (EBA) copolymers, and ethylene n-butyl acrylate (EnBA) copolymers, acrylic acid-ethyl acrylate (AA-EA) copolymers, methacrylic acid ethyl acrylate (MAA-EA) copolymers, ethylene vinyl acetate (EVA) copolymers, polyvinyl alcohol (PVOH) polymers, or combinations thereof.

11. The recyclable, paper-based composite film structure or claim 1, wherein the barrier layer is disposed on the second major surface of the paper substrate.

12. The recyclable, paper-based composite film structure or claim 1, wherein the barrier layer is disposed on the first major surface of the paper substrate.

13. The recyclable, paper-based composite film structure or claim 1, wherein non-fiber components in the recyclable, paper-based composite film structure are in the range of 0% to 20% by weight of the total weight of the recyclable, paper-based composite film structure.

14. The recyclable, paper-based composite film structure or claim 1, wherein the non-water soluble, non-fiber components in the recyclable, paper-based composite film structure are in the range of 0% to 20% by weight of the total weight of the recyclable, paper-based composite film structure minus the weight of any water soluble components in the recyclable, paper-based composite film structure.

15. A packaging article formed of the recyclable, paper-based composite film structure of claim 1.

16. A recyclable, paper-based composite film structure comprising:
a first ply comprising:
a paper substrate having a first major surface and a second major surface opposite the first major surface, the first major surface of the paper substrate configured to face away from a product to be packaged; and
a second ply comprising:
a heat sealable polymer layer having a first major surface and a second major surface opposite the first major surface, the first major surface of the heat sealable polymer layer configured to face toward the second major surface of the paper substrate and the second major surface of the heat sealable polymer layer configured to form an innermost surface of the recyclable, paper-based composite film structure; and
a barrier layer disposed on the first major surface of the heat sealable polymer layer;
an adhesive layer intermediate the first ply and the second ply, the adhesive layer bonding the first ply to the second ply; and
an adhesion promotor disposed intermediate the paper substrate and the heat sealable polymer layer.

17. The recyclable, paper-based composite film structure or claim 16, further comprising one or both of a moisture barrier layer and a printed ink layer disposed on the first major surface of the paper substrate.

18. The recyclable, paper-based composite film structure or claim 16, wherein the adhesion promotor is selected from the group consisting of a primer layer disposed on the second major surface of the paper substrate and a modified surface disposed on the second major surface of the paper substrate.

19. The recyclable, paper-based composite film structure or claim 18, wherein the modified surface is selected from the group consisting of a flame treated surface, a corona treated surface, a plasma treated surface, and an ozone treated surface.

20. The recyclable, paper-based composite film structure or claim 16, wherein the barrier layer is a moisture barrier, an oxygen barrier, or both.

21. The recyclable, paper-based composite film structure or claim 20, wherein the barrier layer is selected from the group consisting of ceramic coatings, inorganic oxide coatings, inorganic nitride coatings, inorganic carbide coatings, aluminum oxide coatings (AlOx), silicon oxide coatings (SiOx), blends of AlOx and SiOx, a metallization layer, an aluminum metallization layer, and polyvinyl alcohol (PVOH) coatings.

22. The recyclable, paper-based composite film structure or claim 20, wherein the recyclable, paper-based composite film structure has one or both of:
an oxygen transmission rate (OTR) in the range of 0.001 cc/100 in²/day to 5 cc/100 in²/day (when tested at 23° C. and 50% relative humidity); and
a water vapor transmission rate (WVTR) in the range of 0.001 cc/100 in²/day to cc/100 in²/day (when tested at 23° C. and 85% relative humidity).

23. The recyclable, paper-based composite film structure or claim 16, wherein the heat sealable polymer layer is formed of a material selected from the group consisting of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), or blends thereof as well as coextrusions thereof, polyesters, polyethylene terephthalate (PET), biaxially oriented polypropylene (BOPP), biaxially oriented polyethylene (BOPE), biaxially oriented polyethylene terephthalate (BOPET), biaxially oriented nylon, cast nylon, blown polypropylene, cast polypropylene, blown polyethylene, and cast polyethylene.

24. The recyclable, paper-based composite film structure or claim 16, wherein non-fiber components in the recyclable, paper-based composite film structure are in the range of 0% to 20% by weight of the total weight of the recyclable, paper-based composite film structure.

25. A packaging article formed of the recyclable, paper-based composite film structure of claim 16.
